(19) United States
(12) Patent Application Publication
(10) Pub. No.: US 2026/0211370 A1
(43) Pub. Date: Jul. 23, 2026

(54) SYSTEM AND METHOD FOR ASSEMBLY OF A PHASE-SHIFTING METASURFACE FOR CONTROLLING COLOR SHADE AND BRIGHTNESS OF DISPLAYED LIGHT IN A HOLOGRAPHIC SKIN

(71) Applicant: Dell Products LP, Round Rock, TX (US)

(72) Inventors: Navjot Kaur Khaira, Manotick (CA); Tejinder Singh, Manotick (CA); Harpreet S. Narula, Austin, TX (US)

(73) Assignee: Dell Products LP, Round Rock, TX (US)

(21) Appl. No.: 19/032,090

(22) Filed: Jan. 19, 2025

(51) Int. Cl. G03H 1/02

(52) U.S. Cl. CPC G03H 1/0272

(57) ABSTRACT

A holographic skin for the display of a holographic image atop an information handling system chassis may comprise a transparent substrate having a first permittivity value, subpixel dual-armed phase-shifting nanostructures formed of a refractive material having a second permittivity value measuring less than one wavelength of visible light, where each subpixel dual-armed phase-shifting nanostructure correlates to a sub-pixel for the holographic image and comprising a dual-armed phase-shifting nanostructure of a refractive material of a second permittivity value. The subpixel nanostructures may include dual-armed phase-shifting nanostructures dimensioned for refracting resonant red, green or blue light to form pixels of the of the holographic image, with each subpixel nanostructure disposed atop the transparent substrate at length and a phase-shift angle relative to an angle of incoming incident light that matches a determined color and brightness for a pixel of a pre-selected image to be displayed as the holographic image.

### FIELD OF THE DISCLOSURE

The present disclosure generally relates to a holographic skin for projecting a holographic image using computer generated holography. The present disclosure more specifically relates to the assembly of a phase-shifting metasurface for controlling shade of color projected via a holographic skin for a laptop keyboard, or a phase-shifting metasurface for controlling brightness of colors projected via a holographic skin on an exterior top surface of an information handling system chassis top cover, each comprising a plurality of phase-shifting dual-armed nanostructures formed at a determined rotated phase angle to project light at a specific color and shade.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system incorporating a phase-shifting metasurface for a holographic skin operatively coupled to a top cover chassis of a digital display device or a phase-shifting metasurface of a holographic skin operatively coupled to a keyboard according to an embodiment of the present disclosure;

FIG. 2A is a graphical diagram illustrating a linear dual-armed phase-shifting nanostructure situated atop a transparent substrate to form a sub-pixel of a phase-shifting metasurface for a holographic skin according to an embodiment of the present disclosure;

FIG. 2B is a graphical diagram illustrating a plurality of linear dual-armed phase-shifting nanostructures, each having a length designed specifically for the display of red, green, or blue wavelengths forming a plurality of sub-pixels of a phase-shifting metasurface for a holographic skin according to an embodiment of the present disclosure;

FIG. 2C is a graphical diagram illustrating a plurality of linear dual-armed phase-shifting nanostructures forming a plurality of red, green, and blue sub-pixels of a phase-shifting metasurface for a holographic skin according to an embodiment of the present disclosure;

FIG. 2D is a graphical diagram illustrating a linear dual-armed phase-shifting nanostructure of a phase-shifting metasurface sub-pixel rotated at a determined phase-shift angle for the display of shades of red, green, or blue light of a holographic skin according to an embodiment of the present disclosure;

FIG. 2E is a graphical diagram illustrating a plurality of linear dual-armed phase-shifting nanostructures, each oriented at an angle with respect to an incident light reference line correlated to a determined phase change angle to display of refracted light at various colored shades of a holographic skin according to an embodiment of the present disclosure;

FIG. 3A is a graphical diagram illustrating an x-shaped dual-armed phase-shifting nanostructure for the control of brightness and the control of color shade of a phase-shifting metasurface of a holographic skin according to an embodiment of the present disclosure;

FIG. 3B is a graphical diagram illustrating a plurality of x-shaped dual-armed phase-shifting nanostructures for controlling an amplitude or brightness and color of refracted light projected via a holographic skin to form a plurality of sub-pixels of a phase-shifting metasurface according to an embodiment of the present disclosure;

FIG. 3C is a graphical diagram illustrating a plurality of x-shaped dual-armed phase-shifting nanostructures as subpixels for controlling brightness and a shade of color of refracted light to form a phase-shifting metasurface of a holographic skin according to an embodiment of the present disclosure;

FIG. 3D is a graphical diagram illustrating an x-shaped phase-shifting dual-armed nanostructure for the control of brightness and color of refracted light for a phase-shifted metasurface of a holographic skin rotated at phase-shift angles between two portions of the x-shaped structure with respect to incident light according to an embodiment of the present disclosure;

FIG. 4A is a graphical diagram illustrating an information handling system with a phase-shifting metasurface of a holographic skin for the projection of a holographic image incorporated as part of a display chassis top cover according to an embodiment of the present disclosure;

FIG. 4B is a graphical diagram illustrating a cross-section of an information handling system chassis top cover incorporating a phase-shifting metasurface of a holographic skin for the projection of a holographic image according to an embodiment of the present disclosure;

FIG. 4C is a graphical diagram illustrating a cross-section of an information handling system chassis top cover incorporating a phase-shifting metasurface of a holographic skin for the projection of a holographic image according to another embodiment of the present disclosure;

FIG. 5 is a graphical diagram illustrating a top exterior surface of a base chassis keyboard of an information handling system incorporating a phase-shifting metasurface of a holographic skin according to an embodiment of the present disclosure;

FIG. 6 is a flow diagram illustrating a method of assembling a phase-shifting metasurface of a holographic skin for the display of a holographic image from clamshell top cover or a keyboard 6of an information handling system according to an embodiment of the present disclosure;

FIG. 7 is a flow diagram illustrating a method of assembling a clamshell top cover for a display chassis of an information handling system with a holographic skin incorporating a phase-shifting metasurface according to an embodiment of the present disclosure; and

FIG. 8 is a flow diagram illustrating a method of assembling a keyboard of an information handling system with a holographic skin incorporating a phase-shifting metasurface according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Computer-generated holography (CGH) generates a holographic image by projecting light onto a surface, referred to herein as a metasurface, that manipulates the incoming light to mimic how light would interact with a known three-dimensional or two-dimensional object. In the case of a holographic image this mimicking process may be conducted with a metasurface and involve the use of computer algorithms to mathematically calculate and simulate properties of the light wavefronts that would be reflected by such a two-dimensional object were the user to view the holographic image directly. A phase-shifting metasurface comprising a known plurality of pixels may then be formed to manipulate incoming visible light using the mathematically determined simulated properties of the light wavefronts to display a holographic image. This phase-shifting metasurface in an embodiment may thus act as a spatial light modulator (SLM). An SLM precisely controls the phase of light at each pixel of its surface or substrate using a pixelated array of SLMs, effectively shaping the light beam into a desired pattern or distribution across the surface of the device.

In one example embodiment of the present disclosure, a user of an information handling system may select a holographic image to display on the exterior surface of an information handling system chassis top cover, or the top surface of a clamshell chassis for a laptop computer, using computer-generated holography incorporated into a clamshell holographic skin as part of the top or outer surface of a clamshell chassis such as with a laptop computer. In another example embodiment of the present disclosure, a plurality of keyboard holographic skins, each for the display of a keyboard for a different language or for different sets of keys and shortcut keys for performing processes of a specific software application, may be assembled using a phase-shifting metasurface of a holographic keyboard skin to display the various language-specific or application-specific keyboard characters. In forming a holographic skin for use on a clamshell chassis or a keyboard, a hardware processor in such embodiments executing machine readable code instructions of a Gerchberg-Saxton algorithm may determine, for a known number of polysilicon, dual-armed phase-shifting nanostructures formed on a substrate of the phase-shifting metasurface for the holographic skin, a phase-shift angle for each of the polysilicon, dual-armed phase-shifting nanostructures to form pixels or sub-pixels needed to produce the colors of a pre-selected holographic image, such as the user-selected image for display on the top surface of a clamshell chassis or the keyboard characters for the language-specific or application-specific keyboard characters. Such a determined phase-shift angle for a given sub-pixel in embodiments herein may correlate to an angle at which a dual-armed phase-shifting nanostructure of a sub-pixel nanostructure, such as a polysilicon, dual-armed phase-shifting nanostructure, may be formed and oriented on a substrate such as glass with respect to an incoming angle of incident light to produce colors needed at that given sub-pixel of the holographic skin to project a portion of the pre-selected holographic image along with a plurality of other pixels formed similarly. The different permittivity or dielectric constant between the polysilicon, dual-armed phase-shifting nanostructures and the substrate, such as glass, upon which they are disposed causes a refraction of the light according to embodiments herein. The length dimension of each of the polysilicon, dual-armed phase-shifting nanostructures, the angle of each of the polysilicon, dual-armed phase-shifting nanostructures relative to the incident light on the polysilicon, dual-armed phase-shifting nanostructures and the substrate operate as subpixels in embodiment of the present disclosure. Further, these polysilicon, dual-armed phase-shifting nanostructures may be generally linear or be x-shaped as disposed on the substrate. In an example embodiment of the present disclosure, the length of each the polysilicon, dual-armed phase-shifting nanostructures in the x-shape, the angle of each of the polysilicon, dual-armed phase-shifting nanostructures at an intersection and relative to the incident light from the substrate on the polysilicon, dual-armed phase-shifting nanostructure in the x-shape operate to alter intensity and polarization of light as subpixels in embodiment of the present disclosure to form colors and shading. The combinations of the plurality of polysilicon, dual-armed phase-shifting nanostructures, either linear or x-shaped, into plural nanostructure pixels on the substrate may be formed to generate colors and/or brightness for images for the holographic skin in the embodiments herein.

In embodiments of the present disclosure, for each sub-pixel, a sub-pixel, dual-armed phase-shifting nanostructure may be formed of polysilicon that may have a length and phase-shift angle designed specifically for the display of red, green, or blue wavelengths through constructive or destructive interference of light refracting through the polysilicon, dual-armed phase-shifting nanostructures such that each sub-pixel nanostructure may form a sub-pixel for the holographic skin. The different permittivity of the dual-armed phase-shifting nanostructures formed on a glass or other substrate may selectively reflect light at a particular wavelength with this adjustment to brightness and polarization for a resonance wavelength for the color red, green, or blue, due to its length and phase-shift angles relative to incident light or the other polysilicon, dual-armed phase-shifting nanostructures in an x-shape. Various combinations of lengths and phase-shift angles of the dual-armed phase-shifting nanostructure sub-pixels are used to match the wavelength of the desired color and light brightness at a particular pixel location. Each of these dual-armed phase-shifting nanostructures, either linear or x-shaped in embodiments of the present disclosure may be disposed atop a transparent substrate, such as glass for example, having a different light permittivity value than the dual-armed phase-shifting sub-pixel nanostructures themselves, to form a sub-pixel for a given color, such as red, green, or blue.

A phase-shifting metasurface may be formed in embodiments herein by disposing a plurality of these dual-armed phase-shifting sub-pixel nanostructures across such a substrate in a pattern of pixels, with each pixel being formed by one or more sub-pixels comprising dual-armed phase-shifting sub-pixel nanostructures dimensioned and set at phase-shift angles for the display of a specific color, such as red, green, or blue. In such a way, the phase-shifting metasurface may have red, green, and blue pixels based on phase-shift of incident light on the dual-armed phase-shifting sub-pixel nanostructures from the substrate in embodiments herein. Further, each of these sub-pixel nanostructures may incorporate a dual-armed nanostructure oriented at a mathematically determined phase-shift angle with respect to a reference line correlating to the angle of incoming incident light, or plural phase-shift angles relative to two sides or portions of an x-shape across the intersection point, to shift the color made visible by each sub-pixel dual-armed phase-shifting nanostructure to correlate to the color a user can see within a pre-selected holographic image. In other words, rotating one or more given dual-armed phase-shifting nanostructures of a sub-pixel nanostructure by a mathematically determined phase angle away from the incident light reference line correlating to the angle of incoming incident light in an embodiment may shift the color made visible by that sub-pixel nanostructure to various shades of red, green, and blue, to provide a gradient of colors perceived by the user within the selected image in embodiments herein. These dual-armed phase-shifting sub-pixel nanostructures may also be adjusted as to angles of its linear or x-shaped structure to incident light also adjust amplitude of refracted light for brightness or shading.

The pixel values for a user-selected image, including the brightness for each sub-pixel needed to produce the digital holographic image, may be determined by measuring the grayscale pixel value (having a value between zero and 255) for each sub-pixel of a desired image. Orienting the dual-armed phase-shifting nanostructures of differing lengths or angles relative to incident light in the case of linear polysilicon, dual-armed phase-shifting nanostructures, or plural phase-shift angles relative to the two sides or portions of an x-shaped structure of the x-shaped dual-armed phase-shifting nanostructure and the incident light, adjusts light amplitudes, and colors, due to destructive or constructive interference of light passing through the sub-pixel nanostructure. Orienting the dual-armed phase-shifting nanostructure at 90 degrees with respect to the dual-armed phase-shifting nanostructure in an embodiment may give a brightness of zero, which allows light of a minimum amplitude number to pass through the sub-pixel nanostructure and minimize brightness. In order to achieve brightness values between zero and 255 in an embodiment, an amplitude shift angle of a percentage between zero and 90 degrees may be correlated to a percentage of known brightness that is between zero and 255 in an example embodiment.

Each of these dual-armed phase-shifting nanostructures may be oriented at such a mathematically determined amplitude shift angle or angles with respect to the dual-armed phase-shifting nanostructure to shift the brightness of the color made visible by each sub-pixel nanostructure via constructive or destructive interference of refracted light to correlate to the color and brightness a user can see within a pre-selected holographic image of the phase-shifting metasurface for the holographic skin. In other words, rotating phase-shift angle or angles of a dual-armed phase-shifting nanostructure of a sub-pixel nanostructure by a mathematically determined phase-shift angle in an embodiment may shift the brightness of the color made visible by that sub-pixel nanostructure to provide differing levels of depth or richness of the displayed red, green, and blue in the displayed image.

In some embodiments, such as for a keyboard holographic skin, the phase-shifting metasurface need not display a large range of color depth or brightness. For example, a phase-shifting metasurface may be appropriate for use in a keyboard skin for projecting a plurality of keyboard characters with pixels of the same brightness as one another. In such an embodiment, use of linear polysilicon, dual-armed phase-shifting nanostructures may be appropriate rather than x-shaped polysilicon, dual-armed phase-shifting nanostructures. In such an embodiment, a phase-shifting metasurface may be disposed between a keyboard backlight and a transparent keyboard cover layer to protect the phase-shifting metasurface materials from outside contamination during use. The keyboard backlight in such an embodiment may emit light through the phase-shifting metasurface, having a plurality of sub-pixels, each comprising a linear dual-armed phase-shifting nanostructure oriented at a phase-shift angle to project light of a specific color and a particular brightness to project an image of a language character or a keyboard shortcut character for a known software application.

In other embodiments, such as for a clamshell top-cover holographic skin, the phase-shifting metasurface may provide for image display with greater richness or depth to color and brightness. This will allow individuals around the laptop information handling system to view the holographic image projected via the phase-shifting metasurface while the laptop is in use. In such an embodiment, use of x-shaped polysilicon, dual-armed phase-shifting nanostructures may be appropriate rather than linear polysilicon, dual-armed phase-shifting nanostructures. In such an embodiment, the phase-shifting metasurface may be disposed between a light source layer of a digital display device within the laptop chassis top cover and a translucent outer cover to protect the phase-shifting metasurface materials from outside contamination during use. The light source layer may be an LCD back light of a display or low-power lasers in such an embodiment to emit light through the phase-shifting metasurface, having a plurality of sub-pixels, each comprising a x-shaped dual-armed phase-shifting nanostructure of particular lengths oriented at a phase-shift angles relative to the intersection of the x-shape and incident light to project light of a specific color and brightness for a user-selected holographic image with high quality color resolution and depth.

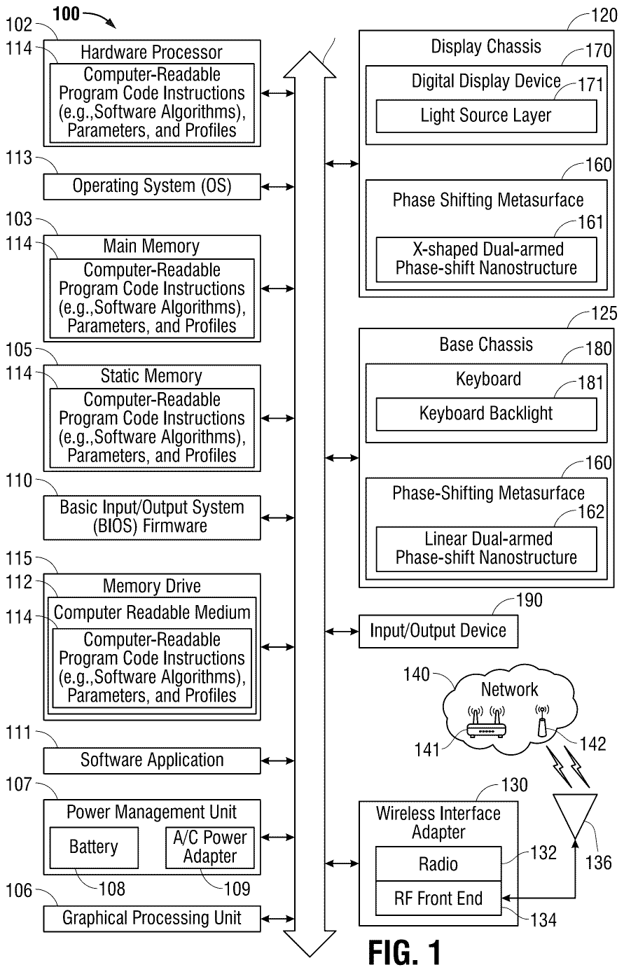

Turning now to the figures, FIG. 1 illustrates an information handling system 100 similar to the information handling systems according to several aspects of the present disclosure. As described herein, computer-generated holography (CGH) generates a holographic image by projecting light onto a holographic skin surface, referred to herein as a phase-shifting metasurface 160 having either x-shaped polysilicon, dual-armed phase-shifting nanostructures 161 as pixels or linear polysilicon, dual-armed phase-shifting nanostructures 162 as pixels that manipulates incoming light to mimic how light would interact with known image elements, such as keyboard characters or a holographic image. A hardware processor 102 executing machine readable code instructions 114 may mathematically calculate and simulate properties of the light wavefronts that would be reflected by such a two-dimensional object to be presented or displayed in the phase-shifting metasurface of the holographic skin. A phase-shifting metasurface 160 comprising a known plurality of pixels may then be formed to manipulate incoming visible light using the mathematically determined simulated properties of the light wavefronts to display a holographic image via the holographic skin. This phase-shifting metasurface 160 in an embodiment may thus act as a spatial light modulator (SLM) to control the phase of light at each pixel of its surface or substrate having either x-shaped polysilicon, dual-armed phase-shifting nanostructures 161 as pixels or linear polysilicon, dual-armed phase-shifting nanostructures 162 as pixels, as described in greater detail herein. These x-shaped polysilicon, dual-armed phase-shifting nanostructures 161 as pixels or linear polysilicon, dual-armed phase-shifting nanostructures 162 as pixels effectively shape an incident light beam from a light source or ambient light into a desired pattern or distribution across the phase-shifting metasurface 160 of the holographic skin.

In one example embodiment, a user of an information handling system 100 may select a holographic image to display on the exterior surface of an information handling system 100 chassis top cover, or the top surface of a clamshell chassis for a laptop computer, using computer-generated holography to form a phase-shifting metasurface 160 with x-shaped polysilicon, dual-armed phase-shifting nanostructures 161 as pixels for a holographic skin. In another example embodiment, a plurality of keyboard holographic skins, each for the display of a keyboard 180 for a different language or for shortcut keys for performing processes of a specific software application 111 may be assembled using a phase-shifting metasurface 160 with linear polysilicon, dual-armed phase-shifting nanostructures 162 as pixels to display the various language-specific or application-specific keyboard characters. More specifically, a specific software application 111, such as Adobe® Photoshop® may have keyboard shortcut keys for performing specific operations within that software application 111 (e.g., cut, paste, rotate, etc.). It is appreciated however that having either x-shaped polysilicon, dual-armed phase-shifting nanostructures 161 as pixels or linear polysilicon, dual-armed phase-shifting nanostructures 162 as pixels may be used with the clamshell chassis holographic skin or with the keyboard holographic skin in various embodiments or combinations.

A hardware processor 102 in such embodiments may executing machine readable code instructions of a Gerchberg-Saxton algorithm to determine, for the phase-shifting metasurface 160, having either a known number of x-shaped polysilicon, dual-armed phase-shifting nanostructures 161 as pixels or a known number of linear polysilicon, dual-armed phase-shifting nanostructures 162 as pixels, a phase-shift angle for each pixel or sub-pixel of the phase-shifting metasurface 160 that are needed to produce the colors of a pre-selected holographic image of a holographic skin. For example, the user-selected image of a clamshell holographic skin or the keyboard characters for the language-specific or application-specific keyboard characters of a keyboard holographic skin may be the pre-selected holographic images. Such determined phase-shift angles in an embodiment may correlate to an angle at which each linear dual-armed phase-shift nanostructure 162 for sub-pixels of the phase-shifting metasurface 160 may be oriented with respect to an incident light reference line correlating to an incoming angle of incident light to produce a color or brightness with constructive or destructive interference of refracted light by the linear dual-armed phase-shift nanostructure 162 needed to project a portion of the pre-selected holographic image for the keyboard holographic skin on a keyboard 180 of a base chassis 125, as described in greater detail herein. The determined phase-shift angles may correlate to an angle at which each side or portion of the x-shaped structure about an intersection point of the x-shaped dual-armed phase-shift nanostructure 161 for sub-pixels of the phase-shifting metasurface 160 may be oriented with respect to an incident light reference line correlating to an incoming angle of incident light to produce a color or brightness. These phase-shift angles and length of the sides of the x-shaped dual-armed phase-shift nanostructure 161 generate constructive or destructive interference of refracted light by the x-shaped dual-armed phase-shift nanostructure 161 to project a portion of the pre-selected holographic image for the clamshell top cover of a holographic skin of a display chassis 120, as described in greater detail herein.

Each of these x-shaped dual-armed phase-shift nanostructure 161 or linear dual-armed phase-shift nanostructure 162 of the phase-shifting metasurfaces 160 in embodiments of the present disclosure may be disposed atop a transparent substrate, such as glass for example, having a different permittivity value than the x-shaped dual-armed phase-shift nanostructures 161 or linear dual-armed phase-shift nanostructures 162 themselves to form a sub-pixel for a given color, such as red, green, or blue based on refractory changes to amplitude and polarization of light. A phase-shifting metasurface 160 may be formed in an embodiment by disposing a plurality of these x-shaped dual-armed phase-shift nanostructures 161 or linear dual-armed phase-shift nanostructures 162 across such a substrate to form a pattern of pixels with dimensions and phase-shift angles for a specific color, such as red, green, or blue and grayscale intensity. In such a way, the phase-shifting metasurface 160 may mimic red, green, and blue pixels as well as brightness levels in the holographic image of the corresponding phase-shifting metasurface 160 of the holographic skin for a clamshell of a display chassis 120 or a keyboard 180 of a base chassis 125.

For example, the brightness of each such sub-pixel may be controlled in an embodiment by orienting the x-shaped dual-armed phase-shift nanostructure 161 or linear dual-armed phase-shift nanostructure 162 relative to an incident light source as well as orienting an angle of two sides of the x-shaped dual-armed phase-shift nanostructure 161 about an intersection point relative to phase-shift angles that correlates to a known brightness for that sub-pixel, as described in greater detail herein. The pixel values for a user-selected image, including the brightness for each sub-pixel needed to produce a user-selected digital holographic image may be determined by a hardware processor 102 executing machine readable code instructions 112 to measure the grayscale pixel value (having a value between zero and 255). Orienting the x-shaped dual-armed phase-shift nanostructure 161 or linear dual-armed phase-shift nanostructure 162 at phase-shift angles relative to incident light causes destructive or constructive interference of refracted light waves to allow light of all amplitudes and varying polarization for colors to pass through the sub-pixel. For example, orienting the x-shaped dual-armed phase-shift nanostructure 161 or linear dual-armed phase-shift nanostructure 162 of a given sub-pixel at an amplitude shift angle of 90 degrees with respect to the dual-armed phase-shifting nanostructure in an example embodiment may give a brightness of zero or a low brightness value, which allows very dark grayscale light or very low light to pass through the sub-pixel and minimize brightness at that subpixel. Other examples of possible amplitude angles correlating to brightness values are contemplated and discussed in embodiments herein. Further, these phase-shift angles of the two sides or portions of the x-shaped dual-armed phase-shift nanostructure 161 or of the linear dual-armed phase-shift nanostructure 162 relative to incident light may determine constructive and destructive interference of refracted light for polarization to various colors for the pixels as generated by the sub-pixels. It is contemplated that any phase angle between zero and 180 degrees may correlate to any brightness value between zero and 255 or any polarization for colors in sub-pixels, and such correlations may, in some cases, be determined through empirical testing, for determination of grayscale and colors of those pixels. In order to achieve brightness values between zero and 255 in an example embodiment, a hardware processor 102 executing machine readable code instructions 112 to correlate an amplitude shift angle of a percentage between zero and 90 degrees to a percentage of known brightness that is between zero and 255 that may be designated for pixels to generate a pre-selected image. Similarly, the angles selected for sub-pixels and the combinations of those sub-pixels in a pixel for the x-shaped dual-armed phase-shift nanostructure 161 or linear dual-armed phase-shift nanostructure 162 may determine colors displayed at those pixels of the phase-shifting metasurface 160. Thus, disposing a plurality of x-shaped dual-armed phase-shift nanostructure 161 or linear dual-armed phase-shift nanostructure 162 in such a way may produce the pre-selected holographic image for a phase-shifting metasurface 160 of a holographic skin in an embodiment.

In some embodiments, such as for a keyboard holographic skin, the phase-shifting metasurface 160 need not display a large range of color depth or brightness. For example, a phase-shifting metasurface 160 may be appropriate for use in a keyboard holographic skin for projecting a plurality of keyboard characters on keyboard 180 with pixels of the same brightness as one another. In such an embodiment, use of polysilicon, linear dual-armed phase-shifting nanostructures 162 may be appropriate rather than x-shaped polysilicon, dual-armed phase-shifting nanostructures 161. In such an embodiment, a phase-shifting metasurface 160 may be disposed between a keyboard backlight 181 and a transparent keyboard cover layer to protect the phase-shifting metasurface materials from outside contamination during use. The keyboard backlight 181 in such an embodiment may emit light through the phase-shifting metasurface 160, having a plurality of sub-pixels, each comprising a linear dual-armed phase-shifting nanostructure 162 oriented at a phase-shift angle to project light of a specific color and a particular brightness to project a holographic image of a language character or a keyboard shortcut character for a known software application.

In other embodiments, such as for a clamshell top-cover holographic skin on a display chassis 120, the phase-shifting metasurface 160 may provide for holographic image display with greater richness or depth to color and brightness. This will allow individuals around the laptop information handling system 100 to view the holographic image projected via the phase-shifting metasurface 160 while the laptop is in use. In such an embodiment, use of polysilicon x-shaped dual-armed phase-shifting nanostructures 161 may be appropriate rather than polysilicon linear dual-armed phase-shifting nanostructures 162. In such an embodiment, the phase-shifting metasurface 162 may be disposed between a light source layer 171 of a digital display device 170 within the top cover of the display chassis 120 and a translucent outer cover to protect the phase-shifting metasurface materials from outside contamination during use. The light source layer 171 may be an LCD back light or OLED light of the display device 170 or low-power lasers as a separate light source in various embodiments to emit light through the phase-shifting metasurface 160, having a plurality of sub-pixels. The sub-pixels of the phase-shifting metasurface 160 may each comprise a x-shaped dual-armed phase-shifting nanostructure 161 of particular lengths with two sides or portions of the x-shape structure oriented at phase-shift angles relative to the incident light to project light of a specific color and brightness for a user-selected holographic image with high quality color resolution and depth for the clamshell top cover holographic skin in embodiments herein. It is contemplated however that the x-shaped dual-armed phase-shifting nanostructures 161 or the linear dual-armed phase-shifting nanostructures 162 may be used in either phase-shifting metasurface for the keyboard holographic skin on keyboard 180 or for the clamshell top cover holographic skin on the display chassis 120 in various embodiments herein.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 115. The information handling system 100 may include or interface with one or more communications ports for communicating with external devices, as well as an input/output (IO) device 190, a video/graphics digital display device 170, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood that any or all portions of machine readable code instructions (e.g., software or firmware algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute machine readable code instructions 114 that are either firmware or software code. For example, the hardware processor 102 in some embodiments may execute machine readable code instructions 114. Moreover, the information handling system 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 190, as well as between hardware processors 102, an EC 104, GPU 106 or other, the operating system (OS) 113, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 190 described herein. As described herein, the information handling system 100 further includes a video/graphics digital display device 170. The video/graphics digital display device 170 in an embodiment may function as a liquid crystal display (LCD), an organic light emitting diode (OLED), a flat panel display, or a solid-state display.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP 2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows®, Android®, and other OS types. Example APIs may include Win 32, Core Java API, or Android APIs.

In an embodiment, the information handling system 100 may include a disk drive unit 115. The disk drive unit 115 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 115, the hardware processor 102 (e.g., CPU), the EC 104, the GPU 106, a video/graphic digital display device 170, or other wired I/O devices 190 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

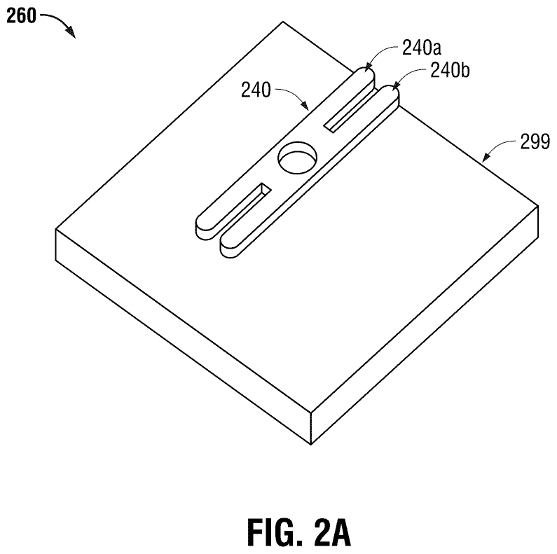

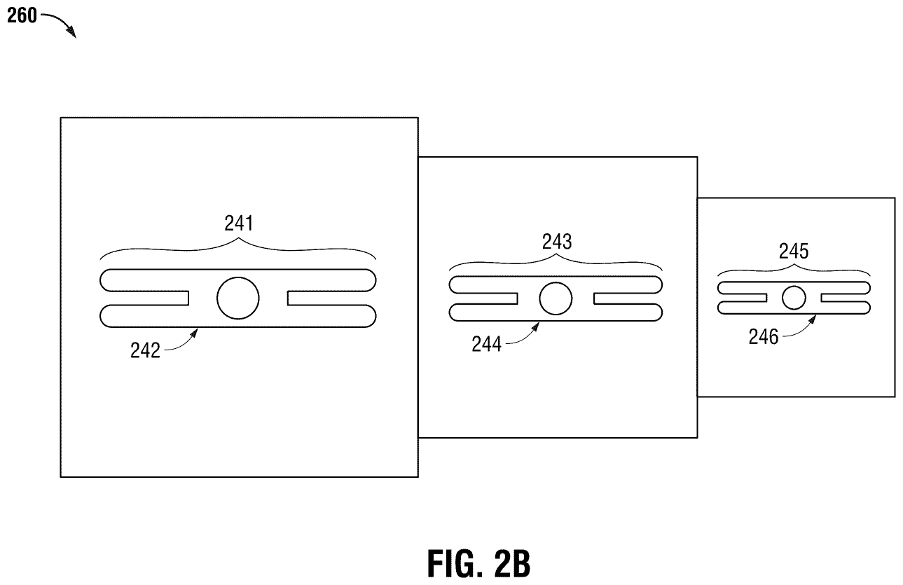

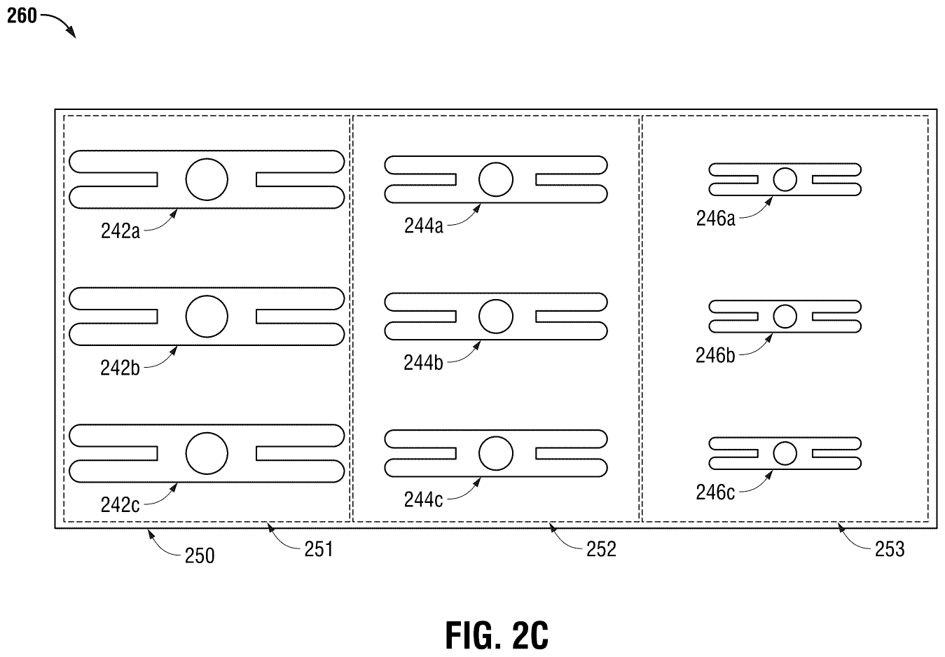

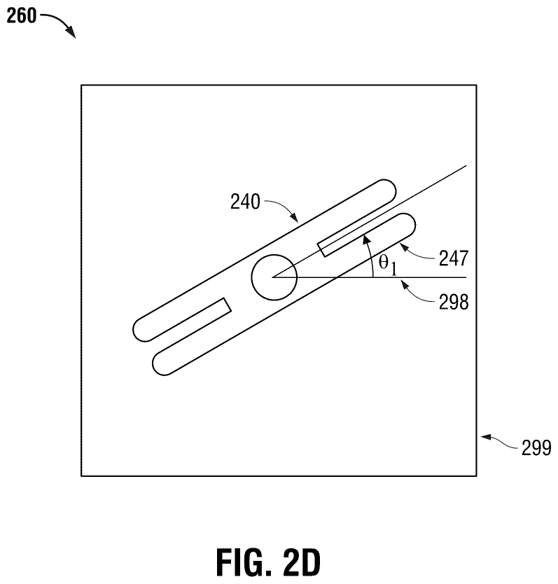

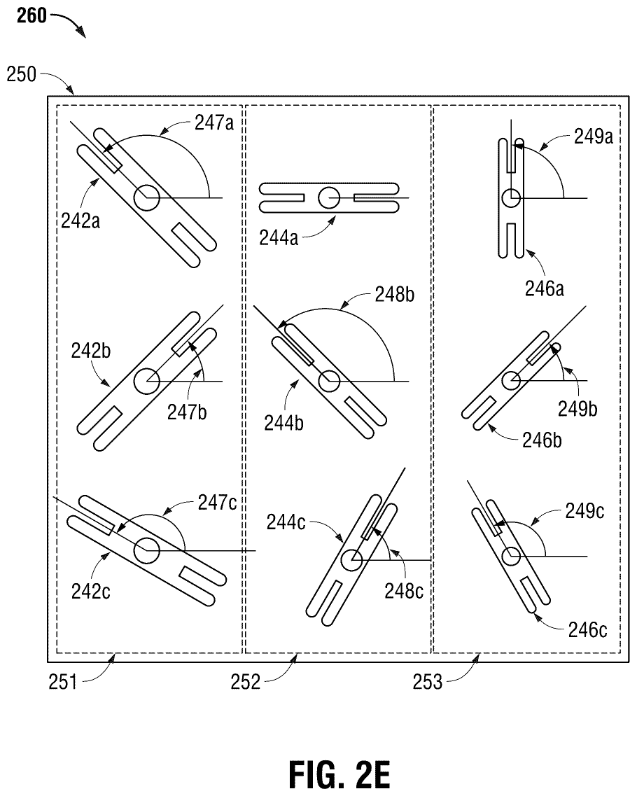

FIG. 2A is a graphical diagram illustrating a linear dual-armed nanostructure of polysilicon material situated atop a transparent substrate to form a sub-pixel of a phase-shifting metasurface acting as a spatial light modulator (SLM) of a holographic skin according to an embodiment of the present disclosure. As described herein, a phase-shifting metasurface 260 comprising a known plurality of pixels may be formed to manipulate incoming visible light using mathematically determined simulated properties of light wavefronts as refracted by linear dual-armed phase-shifting nanostructures 240 to display a holographic image. This phase-shifting metasurface 260 in an embodiment may thus act as an SLM to control the phase of light at each pixel of its surface or substrate using a pixelated array of polysilicon linear dual-armed phase-shifting nanostructures 240, effectively shaping the light beam with refracted and reflected light into a desired pattern or distribution across the surface of the device. Each linear dual-armed phase-shifting nanostructure 240 may include two arms or tines 240a and 240b extending in opposite directions from a center of the linear dual-armed phase-shifting nanostructures 240 in embodiments herein. The dimension of the arms 240a and 240b as well as the space between them, further enhances and provides for effectively shaping the light beam with refracted and reflected light to phase-shift and polarize the light for color and brightness according to embodiments herein. The phase-shifting metasurface 260 in an embodiment may control the phase of light at each pixel by passing light through the plurality of linear dual-armed phase-shifting nanostructures 240 situated atop a transparent substrate 299 having a different permittivity property than the polysilicon of the linear dual-armed phase-shifting nanostructures 240 deposited on the substrate 299. Each of these linear dual-armed phase-shifting nanostructures 240 may be formed of polysilicon material having a first transmittivity value disposed atop a transparent substrate 299 of a second and different transmittivity value to form a single sub-pixel of the metasurface. Refraction and reflection by the linear dual-armed phase-shifting nanostructures 240 from the substrate 299 and the dimension and phase-shift angle of these linear dual-armed phase-shifting nanostructures 240 to incident light, such as light source, may form light at a pixel of the phase-shifting metasurface 260 of varying brightness or colors.

FIG. 2B is a graphical diagram illustrating a plurality of linear dual-armed phase-shifting nanostructures of a polysilicon material, each having a length designed specifically for the display of red, green, or blue wavelengths situated atop a transparent substrate to form a plurality of sub-pixels of a metasurface acting as a spatial light modulator (SLM) of a holographic skin according to an embodiment of the present disclosure. A phase-shifting metasurface 260 may be formed in an embodiment by disposing a plurality of linear dual-armed phase-shifting nanostructures 242, 244, and 246 across such a substrate 299 in a pattern of pixels, with each pixel being formed by one or more sub-pixels having at least one linear dual-armed phase-shifting nanostructure 242, 244, or 246. These dual-armed phase-shifting nanostructure 242, 244, or 246 are dimensioned for a specific color, such as red, green, or blue. Each of these sub-pixel nanostructures comprising dual-armed phase-shifting nanostructures 242, 244, and 246 may have a length 241, 243, and 245 designed specifically for the display of red, green, or blue wavelengths. More specifically, in one example embodiment, the dual-armed phase-shifting nanostructure 242 may have a length 241, for example on the order of 660 nm, designed specifically for resonance for the display of red wavelengths. In another example embodiment, the dual-armed phase-shifting nanostructure 244 may have a length 243, for example on the order of 532 nm, designed specifically for the display of green wavelengths. In yet another example embodiment, the dual-armed phase-shifting nanostructure 246 may have a length 245, for example on the order of 473 nm, designed specifically for the display of blue wavelengths.

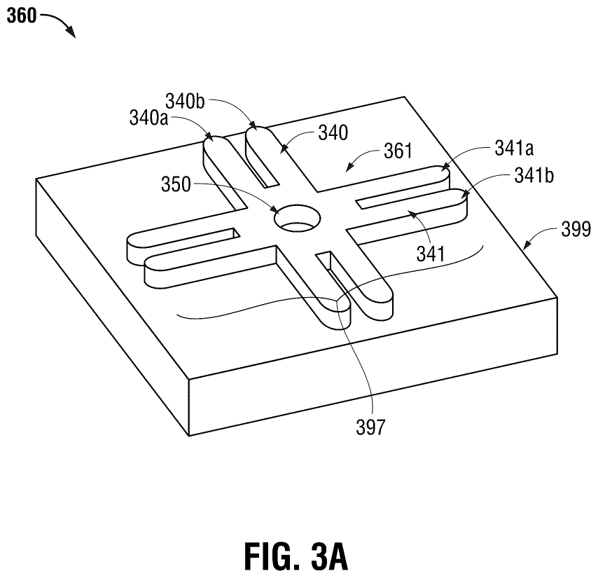

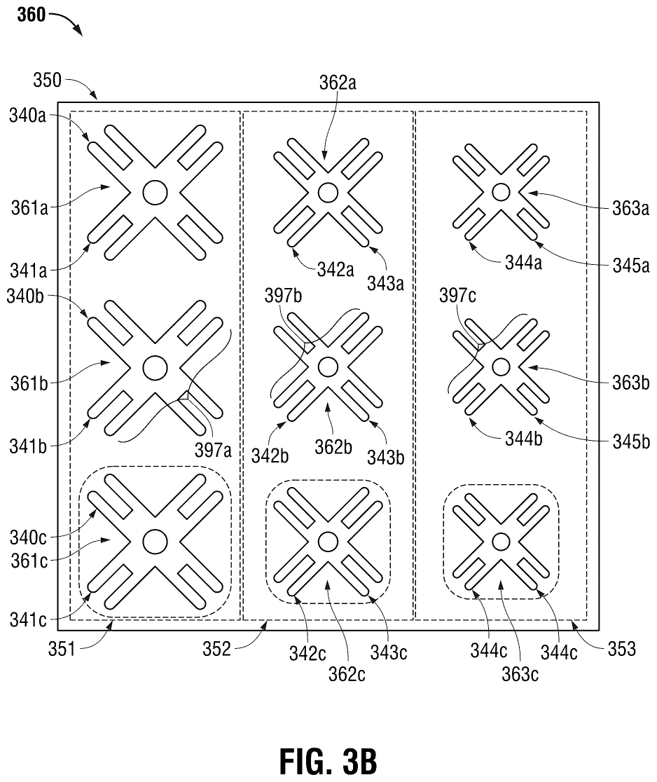

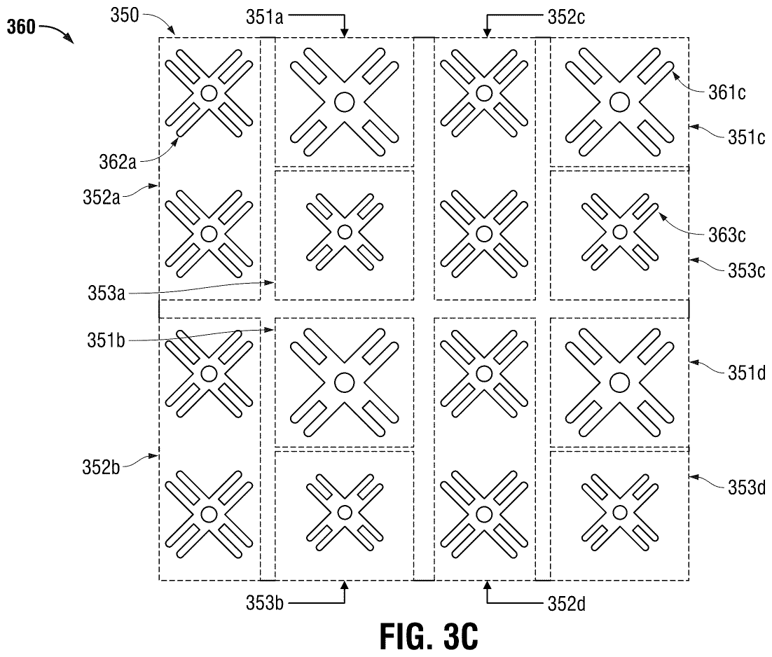

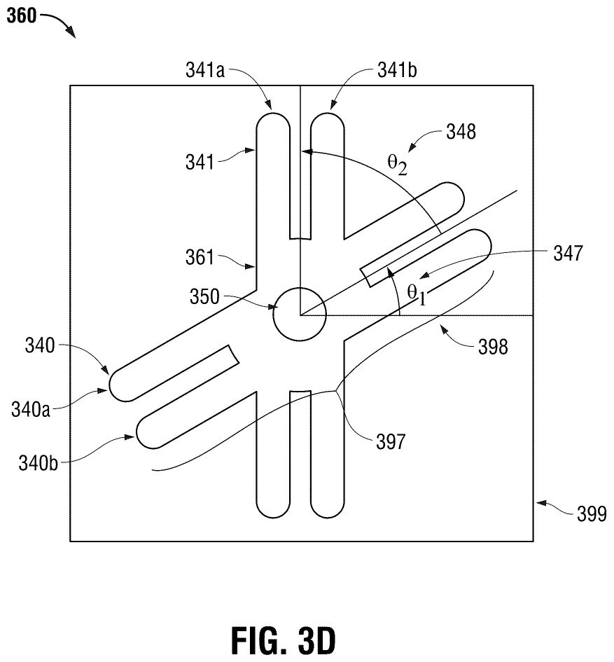

The different permittivity or dielectric constant between the polysilicon linear dual-armed phase-shifting nanostructures 242, 244, or 246 and the substrate 299, such as glass, upon which they are disposed causes a refraction of incoming incident light and resonance of colors based on lengths 242, 244, or 246. Further, the dual arms, including their spacing and length, of the linear dual-armed phase-shifting nanostructures 242, 244, or 246 further enhances the resonance at particular color wavelengths and can yield constructive or destructive interference for polarization of the light in those particular colors. The length of each the polysilicon linear dual-armed phase-shifting nanostructures 242, 244, or 246, the phase-shift angle of each of the polysilicon dual-armed phase-shifting nanostructures 242, 244, or 246 relative to the angle of the incoming incident light on the polysilicon nanostructures 242, 244 or 246 and the substrate 299, and combinations of plural polysilicon linear dual-armed phase-shifting nanostructures 242, 244, or 246 on the substrate 299 (e.g., as described below with respect to FIG. 3D) may be formed to generate colors and brightness at plural pixels for generation of holographic images for the holographic skin.

FIG. 2C is a graphical diagram illustrating a plurality of linear dual-armed phase-shifting nanostructures, each having a length designed specifically for the display of red, green, or blue wavelengths to form a plurality of red, green, and blue sub-pixels that may comprise a pixel of a phase-shifting metasurface according to an embodiment of the present disclosure. Each pixel 250 of the phase-shifting metasurface 260 in an embodiment may comprise one or more red sub-pixels 251, green sub-pixels 252, and blue sub-pixels 253 in embodiments. For example, each red sub-pixel, such as 251 in the holographic skin phase-shifting metasurface 260 may comprise a first plurality of red linear dual-armed phase-shifting nanostructures 242a, 242b, and 242c. As another example, each green sub-pixel, such as 252 in the holographic phase-shifting metasurface 260 may comprise a first plurality of green linear dual-armed phase-shifting nanostructures 244a, 244b, and 244c. In yet another example, each blue sub-pixel, such as 253 in the holographic phase-shifting metasurface 260 may comprise a first plurality of blue linear dual-armed phase-shifting nanostructures 246a, 246b, and 246c.

FIG. 2D is a graphical diagram illustrating a linear dual-armed phase-shifting nanostructure rotated at a phase-shift angle with respect to an incident light reference line correlating to an incoming angle of incident light and a determined phase-shift angle to form a sub-pixel of a phase-shifting metasurface for the display of a specific shade of red, green, or blue light according to an embodiment of the present disclosure. As described herein, a user of an information handling system may select a holographic image to display via the phase-shifting metasurface 260. A hardware processor in an embodiment executing machine readable code instructions of a Gerchberg-Saxton algorithm may determine, for a known number of pixels of the phase-shifting metasurface 260, a phase-shift angle 247 for the linear dual-armed phase-shifting nanostructure 240 of each sub-pixel nanostructure needed to produce the colors and grayscale brightness of pixels for a pre-selected holographic image. Such a determined phase-shift angle 247 in an embodiment may correlate to an angle at which a linear dual-armed phase-shifting nanostructure 240 of polysilicon may be oriented on the substrate 299 with respect to an incident light reference line 298 correlating to an incoming angle of incident light to produce a color shade needed to project a portion of the pre-selected holographic image. In some embodiments, the phase-shift angle 247 may be correlated to the determined phase-shift angle 247 of the linear dual-armed phase-shifting nanostructure 240 needed to produce the user-selected image based on empirical data correlating various phase-shift angles of the polysilicon linear dual-armed phase-shifting nanostructure 240 interfacing with a transparent substrate 299 such as glass for resonant wavelengths of red, green, or blue linear dual-armed phase-shifting nanostructures such as 240.

Each of these linear dual-armed phase-shifting nanostructures 240 may be oriented at an phase-shift angle 247, relative to incident light reference line 298, and correlated to a mathematically determined phase-shift cause by that phase-shift angle 247 to shift the color and amplitude of light made visible by resonance of light from that particular linear dual-armed phase-shifting nanostructures 240. In this way, the length, as described above in FIG. 2B, as well as the phase-shift angle 247 of the linear dual-armed phase-shifting nanostructure 240 correlate to the color and shade at a sub-pixel for a pixel that a user can see as part of a pre-selected holographic image in the holographic skin. In other words, rotating a given linear dual-armed phase-shifting nanostructure 240 of a sub-pixel by an angle 247 correlating to a mathematically determined phase-shift angle 247 away from the horizontal or other orientation reference line, which may be an incident light reference line 298, in an embodiment may shift the color and amplitude of refracted light made visible by that linear dual-armed phase-shifting nanostructure 240 to various shades of red, green, and blue, depending on the length and phase-shift angle 247 of the linear dual-armed phase-shifting nanostructure 240. In this way, the phase-shifting metasurface 260 may provide a gradient of colors in a holographic image of the holographic skin perceived by the user.

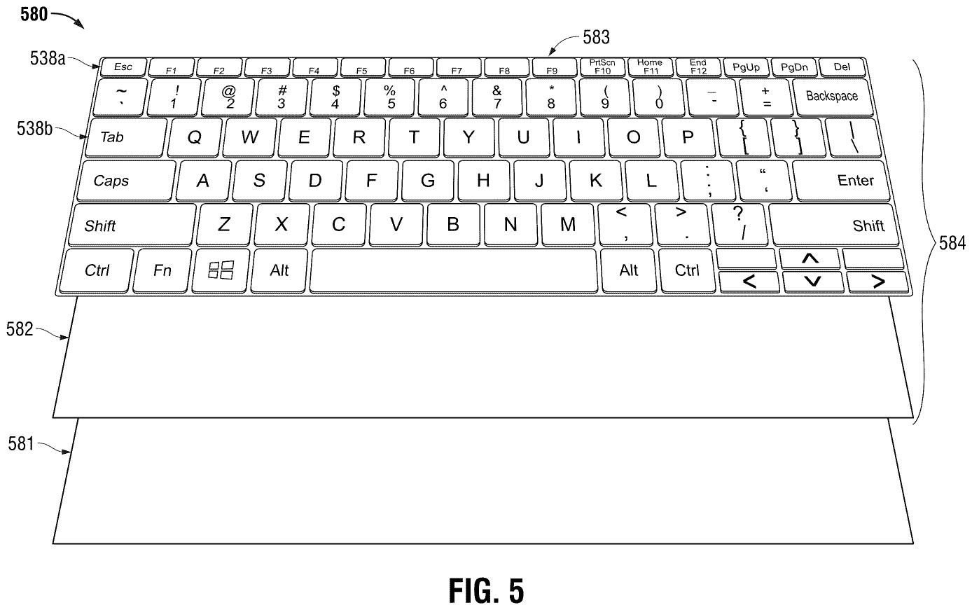

FIG. 2E is a graphical diagram illustrating a plurality of linear dual-armed phase-shifting nanostructures, each oriented at a phase-shift angle with respect to a reference line correlated to an incoming angle of incident light and varying lengths a determined to display light at various colored shades from a plurality of red, green, and blue sub-pixels of a phase-shifting metasurface according to an embodiment of the present disclosure. Each pixel 250 of the phase-shifting metasurface 260 in an embodiment may comprise one or more red sub-pixels 251, green sub-pixels 252, and blue sub-pixels 253. For example, each red sub-pixel, such as 251 in the holographic phase-shifting metasurface 260 may comprise a first plurality of red linear dual-armed phase-shifting nanostructures 242a, 242b, and 242c, each rotated at phase-shift angle 247a, 247b, and 247c, respectively, that modulates the phase of red light refracted to enable precise image formation for projecting light at various shades of red. As another example, each green sub-pixel, such as 252 in the holographic phase-shifting metasurface 260 may comprise a first plurality of green linear dual-armed phase-shifting nanostructures 244a, 244b, and 244c each rotated at an phase-shift angle of zero, 248b, and 248c, respectively, that modulates the phase of green light refracted to enable precise image formation for projecting light at various shades of green. In yet another example, each blue sub-pixel, such as 253 in the holographic phase-shifting metasurface 260 may comprise a first plurality of blue linear dual-armed phase-shifting nanostructures 246a, 246b, and 246c, each rotated at a phase-shift angle 249a, 249b, and 249c, respectively, that modulates the phase of blue light refracted to enable precise image formation for projecting light at various shades of blue. As described in greater detail below with respect to FIG. 5 below, in an embodiment in which the holographic image is to be displayed on a keyboard skin within the information handling system chassis base cover, a translucent keyboard cover material may be disposed atop the phase-shifting metasurface 260 displaying a plurality of key characters for one or a plurality of languages or one of a plurality of software application functions or tools to produce a language or software application specific keyboard skin.

FIG. 3A is a graphical diagram illustrating an x-shaped dual-armed phase-shifting nanostructure for the control of brightness and control of color shade disposed atop a transparent substrate to form a sub-pixel nanostructure of a phase-shifting metasurface of a holographic skin according to an embodiment of the present disclosure. In an embodiment, the brightness and color shade of each such sub-pixel of a phase-shifting metasurface 360 in an embodiment may be controlled by disposing an x-shaped dual-armed phase-shifting nanostructure 361 of a length dimension on both portions 340, 341 of the x-shaped structure relative to a wavelength of light to be resonated, such as red, green, or blue to refract or reflect light to resonance at those respective colors. Each x-shaped dual-armed phase-shifting nanostructure 361 may include two arms or tines 340a, 340b and 341a, 341b for each portion 340 and 341 respectively of the x-shaped structure extending in opposite directions from a center of the x-shaped dual-armed phase-shifting nanostructure 361 in embodiments herein. The dimension of the arms 340a, 340b, 341a, and 341b as well as the space between the tines or arms, further enhances and provides for effectively shaping the light beam with refracted and reflected light to phase-shift and polarize the light for color and brightness according to embodiments herein. Further, the portions 340 and 341 about an intersection point 350 of the x-shape structure of the x-shaped dual-armed phase-shifting nanostructure 361 may be oriented at a first phase-shift angle and a second phase-shift angle with respect to an incident light reference line. Both the first and second phase-shift angles contribute to phase modulation by the x-shaped dual-armed phase-shifting nanostructure 361 as does the length of the portions 340 and 341 of the x-shaped dual-armed phase-shifting nanostructure 361. Thus, the plural phase-shift angles of portions 340 and 341 of the x-shape structure of the x-shaped dual-armed phase-shifting nanostructure 361 along with their length 397 determine a greater level of variation for colors and shades available at a higher pixel density with the x-shaped dual-armed phase-shifting nanostructure 361 than, say, with a linear dual-armed phase-shifting nanostructure described above.

For each sub-pixel utilizing the x-shaped dual-armed phase-shifting nanostructure 361 in a phase-shifting metasurface 360 of the holographic skin, the x-shaped dual-armed phase-shifting nanostructure 361 may be formed of a refractive material such as polysilicon and disposed on a transparent substrate 399 such as glass with a different light permittivity. This interface of the polysilicon x-shaped dual-armed phase-shifting nanostructure 361 formed on the substrate causes refraction and reflection of the light. Thus, the length 397 of the portions 340 and 341 of the x-shaped dual-armed phase-shifting nanostructure 361 correspond to resonance of light wavelengths of red, green, and blue in various embodiments. This length 397, along with the plural phase-shift angles of portions 340 and 341 of the x-shaped dual-armed phase-shifting nanostructure 361 discussed further below, cause a phase-shift and polarization of the refracted light with constructive or destructive interference to resonate light at varying color wavelengths and at varying levels of grayscale brightness of light passing through a given x-shaped dual-armed phase-shifting nanostructure 361 in a sub-pixel.

FIG. 3B is a graphical diagram illustrating a plurality of x-shaped dual-armed phase-shifting nanostructures for controlling color shade and an amplitude or brightness of light projected via the holographic skin to form a plurality of sub-pixels of a phase-shifting metasurface according to an embodiment of the present disclosure. A phase-shifting metasurface 360 may be formed in an embodiment by forming a plurality of sub-pixel nanostructures to each incorporate one or more x-shaped dual-armed phase-shifting nanostructures 361a, 361b, 361c, 362a, 362b, 362c, 363a, 363b, or 363c. The x-shaped dual-armed phase-shifting nanostructures 361a, 361b, 361c, 362a, 362b, 362c, 363a, 363b, or 363c having two portions 340a, 341a, 340b 341b, 340c, 341c, 342a, 343b, 342b, 343b, 342c, 343c, 344a, 345a, 344b, 345b, 344c, and 345c respectively for each of the x-structure about a center intersection point as described above. The plurality of x-shaped dual-armed phase-shifting nanostructures 361a, 361b, 361c, 362a, 362b, 362c, 363a, 363b, or 363c are disposed on a transparent substrate 399 in a pattern of pixels such as 350. Each pixel 350 in an embodiment may be formed by one or more sub-pixels 351, 352, or 353 comprising the x-shaped dual-armed phase-shifting nanostructures 361a, 361b, 361c, 362a, 362b, 362c, 363a, 363b, or 363c having a length 397 dimensioned for a specific color, such as red, green, or blue. Further, the x-shaped dual-armed phase-shifting nanostructures 361a, 361b, 361c, 362a, 362b, 362c, 363a, 363b, or 363c in sub-pixels 351, 351, and 352 may be angled via plural phase-shift angles relative to incident light among sub-pixels 351, 352, 353 and among a plurality pixels 350 as described in embodiments herein.

Each pixel 350 in an embodiment may be formed to include one or more red sub-pixels 351, comprising x-shaped dual-armed phase-shifting nanostructures 361a, 361b, and 361c with a length 397 dimensioned for the projection of various shades of red at various brightnesses. In an example embodiment, this length 397 for the x-shaped dual-armed phase-shifting nanostructures 361a, 361b, and 361c with a length 397 may be sized for resonance of 660 nm. As another example, each pixel 350 in an embodiment may be formed to include one or more green sub-pixels 352, comprising x-shaped dual-armed phase-shifting nanostructures 362a, 362b, and 362c, with a length 397 dimensioned for the projection of various shades of green at various brightnesses. In an example embodiment, this length 397 for the x-shaped dual-armed phase-shifting nanostructures 362a, 362b, and 362c with a length 397 may be sized for resonance of 532 nm. In another example, each pixel 350 in an embodiment may be formed to include one or more blue sub-pixels 353, comprising phase-shifting dual-armed nanostructures 363a, 363b, and 363c with a length 397 dimensioned for the projection of various shades of blue at various brightnesses. In an example embodiment, this length 397 for the x-shaped dual-armed phase-shifting nanostructures 363a, 363b, and 363c with a length 397 may be sized for resonance of 473 nm.

FIG. 3C is a graphical diagram illustrating a plurality of sub-pixel nanostructures, each comprising x-shaped dual-armed phase-shifting nanostructures for controlling color shade and an amplitude or brightness of light projected via a holographic skin to form a plurality of red, green, and blue sub-pixels of a phase-shifting metasurface according to another embodiment of the present disclosure. FIG. 3C shows a pixel 350 of the phase-shifting metasurface 360 in a different sub-pixel layout in an embodiment. Pixel 350 may comprise one or more red sub-pixels 351a, 351b, 351c, and 351d, green sub-pixels 352a, 352b, 352c, and 352d, and blue sub-pixels 353a, 353b, 353c, and 353c. For example, each red sub-pixel, such as 351c in the phase-shifting metasurface 360 may comprise one or more red x-shaped dual-armed phase-shifting nanostructures such as 361c sized for red light resonance of refracted light by the x-shaped dual-armed phase-shifting nanostructures 361c. As another example, each green sub-pixel, such as 352a in the phase-shifting metasurface 360 may comprise one or more green x-shaped dual-armed phase-shifting nanostructures such as 362a. In yet another example, each blue sub-pixel, such as 353c in the phase-shifting metasurface 360 may comprise one or more blue x-shaped dual-armed phase-shifting nanostructures such as 363c. The layout of pixel 350 and red sub-pixels 351a, 351b, 351c, and 351d, green sub-pixels 352a, 352b, 352c, and 352d, and blue sub-pixels 353a, 353b, 353c, and 353c with the plurality of x-shaped dual-armed phase-shifting nanostructures may provide better color resolution for display of holographic images via the phase-shifting metasurface 360 in a holographic skin in an embodiment. The pixel layout of FIG. 3C is yet one other example and any variety of pixel layouts of pixel 350 is contemplated for the phase-shifting metasurface 360 in various embodiments herein.

FIG. 3D is a graphical diagram illustrating x-shaped dual-armed phase-shifting nanostructures for the control of color and brightness of light projected via a holographic skin rotated at a plural angles correlating to determined phase-shift angles of both portions of the x-shaped dual-armed phase-shifting nanostructures with respect to an incident light source according to an embodiment of the present disclosure. The pixel values for a user-selected image, including the brightness for each sub-pixel needed to produce the digital holographic image may be determined by measuring the grayscale pixel value (having a value between zero and 255) and determining color values. Orienting both portions 340 and 341 of the x-shaped dual-armed phase-shifting nanostructures 361 at phase-shift angles θ₁ 347 and θ₂ 348 may determine brightness and color shade of refracted light from an incident light source direction or other reference direction 398. Second phase-shift angle θ₂ 348 may be an additional angle to the first phase-shift angles θ₁ 347 between the portions 340 and 341 of the x-shaped dual-armed phase-shifting nanostructures 361 relative to one another about a center intersection point 350 in embodiments herein.

Phase-shifting refracted light with the phase-shift angles θ₁ 347 and θ₂ 348 of the x-shaped dual-armed phase-shifting nanostructure 361 may be adjusted to allow light of selected amplitudes to pass through the sub-pixel and set brightness and color. These phase-shift angles θ₁ 347 and θ₂ 348 of the x-shaped dual-armed phase-shifting nanostructures 361 may be set at angles to affect brightness amplitude levels between brightness values between zero and 255 in an embodiment. Thus, the phase-shift angles θ₁ 347 and θ₂ 348 may be set between zero and 180 degrees from an incident light source direction or other reference direction 398 that may be correlated to a percentage of known brightness that is between zero and 255. Additionally, the phase-shift angles θ₁ 347 and θ₂ 348 and lengths 397 of the x-shaped dual-armed phase-shifting nanostructure 361 shift refracted light with respect to the brightness of the color made visible by each sub-pixel to correlate to the color and brightness a user can see within a pre-selected holographic image. In other words, rotating a x-shaped dual-armed phase-shifting nanostructure 361 at a particular length dimension 397 for portions 340 and 341 of a sub-pixel by a mathematically determined phase-shift angles θ₁ 347 and θ₂ 348 from an incident light source direction or other reference direction 398 in an embodiment may shift the brightness of the color made visible by that sub-pixel to provide differing levels of depth or richness of the displayed red, green, and blue. Forming each sub-pixel nanostructure from the x-shaped dual-armed phase-shifting nanostructure 361 at various lengths 397 and phase-shift angles θ₁ 347 and θ₂ 348 in such a way may produce a phase-shifting metasurface 360 for a holographic skin in embodiments herein.

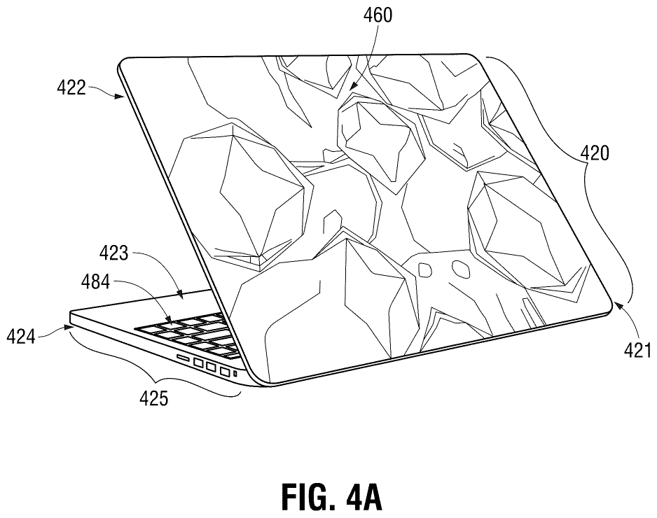

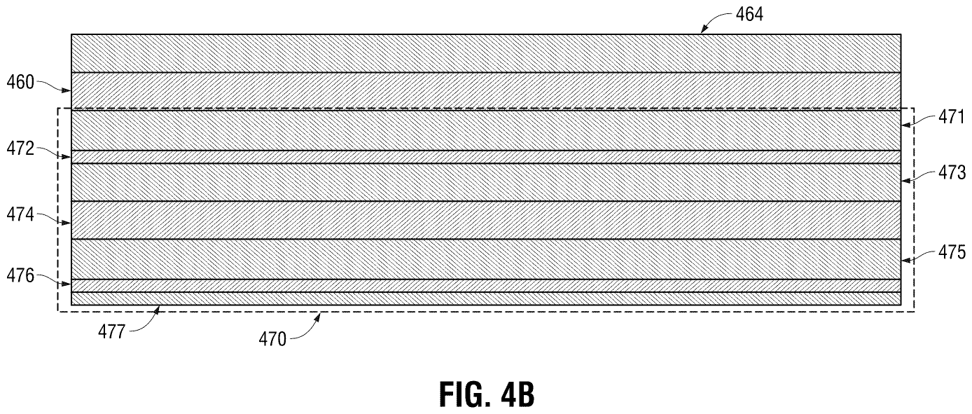

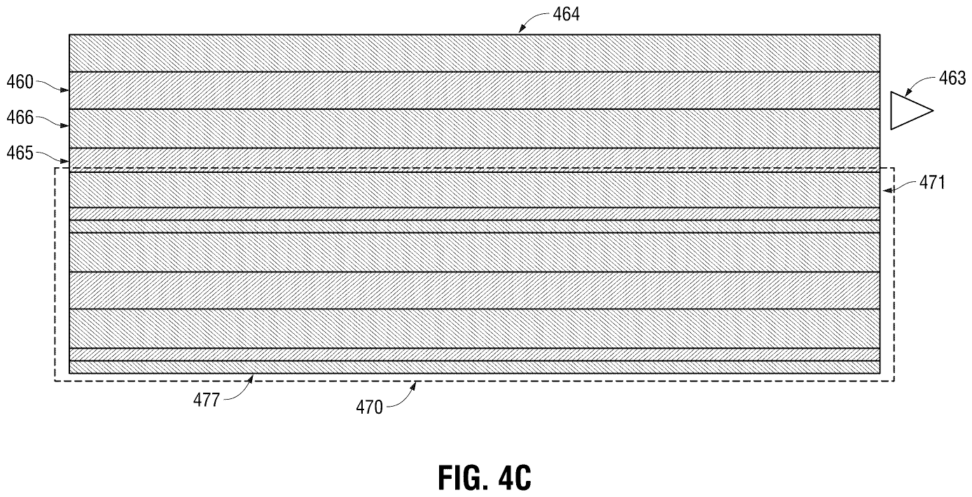

FIG. 4A is a graphical diagram illustrating a phase-shifting metasurface of a holographic skin for the projection of a holographic image incorporated as part of an information handling system chassis top cover according to an embodiment of the present disclosure. A user of an information handling system may select a holographic image to display on the exterior surface of an information handling system chassis top cover 421, or the top surface of a clamshell display chassis 420 for a laptop computer, using computer-generated holography. The clamshell display chassis 420 in an embodiment may comprise, for example, a display chassis top cover 421, a display screen surface or display chassis bezel 422, a base chassis top cover 423, into which a keyboard with a keyboard skin 484 may be incorporated, and a base chassis bottom cover 424. In another example embodiment, a plurality of keyboard skins 484, each for the display of a keyboard for a different language or for shortcut keys for performing processes of a specific software application may be assembled using a phase-shifting metasurface to display the various language-specific or application-specific keyboard characters.

FIG. 4B is a graphical diagram illustrating a cross section of an information handling system display chassis top cover incorporating a phase-shifting metasurface of a holographic skin for the projection of a holographic image atop an exterior top surface of a laptop clamshell case for a display chassis of an information handling system according to an embodiment of the present disclosure. As described herein, the phase-shifting metasurface 460 may use x-shaped dual-armed phase-shifting nanostructures to provide holographic image display richness or depth such as for the display of a user-selected image on an exterior surface of a laptop clamshell display chassis top cover. This will allow individuals around the laptop information handling system to view the holographic image projected via the phase-shifting metasurface 460 while the laptop is in use. In the embodiment of FIG. 4B, the display chassis cross-section is depicted such that the user-facing digital display screen cover glass 477 is at the bottom and the outer-surface of the top cover holographic skin translucent outer cover 464 of the phase-shifting metasurface 460 is at the top.

In such an embodiment depicted in FIG. 4B, the phase-shifting metasurface 460 may be disposed between a light source layer 471 of a digital display device within the laptop display chassis top cover and a translucent outer cover 464 to protect the phase-shifting metasurface 460 materials from outside contamination during use. The light source layer 471 in such an embodiment may emit light through the phase-shifting metasurface 460, having a plurality of sub-pixel nanostructures, such as the x-shaped dual-armed phase-shifting nanostructures described in embodiments herein of given lengths and orientation at a phase-shift angles (e.g., θ₁ and θ₂) with respect to the angle of incoming incident light from the light source layer 471 to project light of a specific color and amplitude at a plurality of x-shaped dual-armed phase-shifting nanostructure pixels, as described in greater detail above with respect to FIGS. 3A, 3B, 3C, and 3D. Light from the light source layer 471 may be directed to a required incident angle of light via light guide or other light structures to the phase-shifting metasurface 460 in embodiments herein. For example, the light from light source layer 471 of the digital display device 470 may be directed on any side of the substrate of the phase-shifting metasurface 460 such that the incident angle of light on the x-shaped dual-armed phase-shifting nanostructures is achieved to provide the colors and brightness for a holographic image.

The light source layer 471 in an embodiment may be the light source layer 471 for a digital display device, such as an LCD for the information handling system chassis top cover. In such an embodiment, further layers of the digital display device may be combined with the light source layer 471. For example, an outer polarizing filter 472 may be disposed between the light source layer 471 and a thin film transistor (TFT) substrate 473. A liquid crystal layer 474 for the digital display device may be disposed in an embodiment between the TFT substrate 473 and a color filter substrate 475 in the display chassis of the information handling system. In an embodiment, an inner polarizing filter 476 may be disposed between the color filter substrate 475 and a digital display cover glass 477, where the user may view a LCD displayed images, via the digital display 470 while the holographic image is projected via the metasurface 460 through the translucent outer cover 464. In other embodiments, the digital display device may be an OLED device not having a separate light source layer 471 and instead the OLED layer provides light and serves as a light source layer to provide light to and through the phase-shifting metasurface 460.

FIG. 4C is a graphical diagram illustrating a cross section of an information handling system chassis top cover incorporating a phase-shifting metasurface of a holographic skin with a dedicated light source and a support plate for the projection of a two-dimensional holographic image atop an exterior top surface of a laptop clamshell case within an information handling system display chassis top cover according to another embodiment of the present disclosure. As described herein, the phase-shifting metasurface 460 may use x-shaped dual-armed phase-shifting nanostructures to provide holographic image display richness or depth such as for the display of a user-selected image on an exterior surface of a laptop clamshell display chassis top cover. This will allow individuals around the laptop information handling system to view the holographic image projected via the phase-shifting metasurface 460 while the laptop is in use. In the embodiment of FIG. 4C, the display chassis cross-section is depicted such that the user-facing digital display screen cover glass 477 is at the bottom and the outer-surface of the top cover holographic skin translucent outer cover 464 of the phase-shifting metasurface 460 is at the top.

As described herein, the light source layer in some embodiments may be the light source layer 471 for a digital display device 470, such as an LCD for the information handling system chassis top cover. In other embodiments, such as shown in FIG. 4C, an opaque support frame 465 through which light may not pass, or through which the passage of light may be hindered may be disposed between the phase-shifting metasurface 460 and the light source 471 for the digital display device 470. For example, the holographic skin including the holographic skin translucent outer cover 464 of the phase-shifting metasurface 460 may be operatively coupled to a display chassis outer surface in an embodiment and require a separate light source 463 or light source layer 464. In such an embodiment, an additional light source 462 such as low-power lasers may be incident on the substrate of the phase-shifting metasurface 460 or on a metasurface light source layer 466 may be added for directing the angles of the emission of light through the phase-shifting metasurface 460. In an embodiment in which the information handling system chassis top cover encloses a support frame 465 disposed between the light source layer 471 for the digital display device and the translucent chassis top outer cover 464 from which the holographic image is to be displayed, the support frame 465 may be disposed on the outside surface of the LCD light source layer 471 for the LCD or digital display device to provide structural support for the chassis top cover. The additional light source 463 and metasurface light source layer 466 may then be disposed between the support frame 465 and at or under the phase-shifting metasurface 460, such that light is emitted from the additional light source 463 or via the metasurface light source layer 466 through the phase-shifting metasurface 460 and directed on any side of the substrate of the phase-shifting metasurface 460, for example, such that the incident angle of light on the x-shaped dual-armed phase-shifting nanostructures is achieved to provide the colors and brightness for a holographic image.

FIG. 5 is a graphical diagram illustrating a phase-shifting metasurface for the projection of holographic images of key characters via a top exterior surface of an information handling system chassis base cover incorporating a keyboard according to an embodiment of the present disclosure. As described herein, the phase-shifting metasurface 582 may use linear dual-armed phase-shifting nanostructures in embodiments herein in displays that do not require a large range of depth or brightness. For example, a phase-shifting metasurface 582 may be appropriate for use in a keyboard skin 584 for projecting a plurality of keyboard characters 583a or 583b on a keyboard 580 of the same brightness as one another. In such an embodiment, a phase-shifting metasurface 582 may be disposed between keys over a keyboard backlight 581 and a transparent keyboard cover layer 583 to protect the phase-shifting metasurface 582 materials from outside contamination during use. The keyboard backlight 581 in such an embodiment may emit light through keyboard keys and the phase-shifting metasurface 582 disposed thereon of keyboard 580, having a plurality of sub-pixel nanostructures, each comprising linear dual-armed phase-shifting nanostructures oriented at a phase-shift angles with respect to the angle of incoming incident light from the keyboard backlight 581 at a light angle to project light of a specific color and brightness, including black, to project an image of a language character or a keyboard shortcut character for a known software application in example embodiments herein. The keyboard key holographic skin 584 may be fixed over keyboard keys, such as via magnetic or interference fit, and may be removable and replaceable in some embodiments. In other embodiments, the keyboard key holographic skin 584 may be formed onto the keys of the keyboard 580.

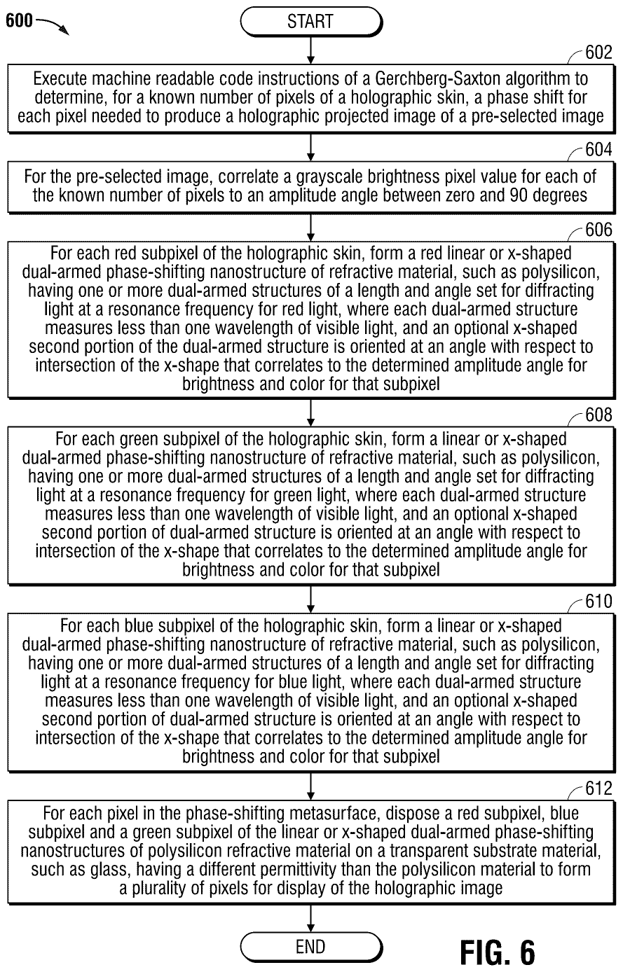

FIG. 6 is a flow diagram illustrating a method of assembling a phase-shifting metasurface for the display of a holographic image in a holographic skin atop an exterior surface of an information handling system according to an embodiment of the present disclosure. As described herein, in one example embodiment of the present disclosure, a user of an information handling system may select a holographic image using computer-generated holography to display, via a phase-shifting metasurface holographic skin, on an exterior surface of an information handling system. In example embodiments, the phase-shifting metasurface holographic skin may be installed or disposed on a display chassis top cover, or the top surface of a clamshell chassis for a laptop computer or a back surface of a tablet or other information handling system having a digital display device. In another example embodiment of the present disclosure, a plurality of keyboard skins for keyboard keys, each for the display of a keyboard for a different language characters or for shortcut key characters for performing processes of a specific software application may be assembled using a phase-shifting metasurface holographic skin to display various language-specific or application-specific keyboard characters on keyboard keys of a keyboard in a base chassis of an information handling system such as a laptop computer.

At block 602, a hardware processor executing machine readable code instructions of a Gerchberg-Saxton algorithm may determine, for a known number of pixels or sub-pixels of a holographic skin, a phase-shift for each pixel or sub-pixel needed to produce a holographic projected image of a pre-selected holographic image.

In an example embodiment described with respect to FIG. 4A, a user of an information handling system may select a holographic image to display on the exterior surface of an information handling system display chassis top cover such as the top surface of a clamshell display chassis 421 for a laptop computer, using computer-generated holography. In another example embodiment, a plurality of keyboard skins 484, each for the display of a keyboard key character for a different language or for shortcut keys for performing processes of a specific software application may be assembled using a phase-shifting metasurface to display the various language-specific or application-specific keyboard characters.

As also described in an embodiment with respect to FIG. 1, a user of an information handling system 100 may select a holographic image to display on the exterior surface of an information handling system 100 chassis top cover, or the top surface of a clamshell chassis for a laptop computer, using computer-generated holography. In another example embodiment, a plurality of keyboard skins, each for the display of a keyboard 180 for a different language or for shortcut keys for performing processes of a specific software application 111 may be assembled using a phase-shifting metasurface 182 to display the various language-specific or application-specific keyboard characters. More specifically, a specific software application 111, such as Adobe® Photoshop® may have keyboard shortcut keys for performing specific operations within that software application 111 (e.g., cut, paste, rotate, etc.). A hardware processor 102 in such an embodiment may executing machine readable code instructions of a Gerchberg-Saxton algorithm to determine from a pre-selected image, phase-shift profile and amplitude profile for a known number of pixels of the phase-shifting metasurface 160. In other embodiments, execution of code instruction for an angular spectrum method system may detect phase-shift profile and amplitude profile from the pre-selected image. With this phase-shift profile and amplitude profile, a phase-shift angles of the linear or x-shaped dual-armed phase-shift nanostructures as well as selected lengths of the linear or x-shaped dual-armed phase-shift nanostructures for each pixel or sub-pixel of the phase-shifting metasurface 160 may be determined to produce the colors of a user pre-selected image in a holographic image. Such a holographic image may then be displayed in the phase-shifting metasurface of the holographic skin for a clamshell display chassis holographic skin or for the keyboard characters for the language-specific or application-specific keyboard characters keyboard holographic skin.

For the pre-selected image in an embodiment at block 604, a grayscale brightness pixel value for each of the known number of pixels or sub-pixels may be correlated to brightness values for a phase-shift angle between zero and 180 degrees relative to incident light. For example, a phase-shift angle 90 degrees may be a minimum brightness level in some embodiments. As described herein, the brightness of each such sub-pixel may be controlled in an embodiment, in addition to the color shade, by orienting an x-shaped dual-armed phase-shifting nanostructure or a linear dual-armed phase-shifting nanostructure at phase-shift angle relative to incident light to form a sub-pixel nanostructure for that sub-pixel.

For example, in an embodiment described with respect to FIG. 1, the pixel values for a user-selected image, including the brightness for each sub-pixel needed to produce a user-selected holographic image may be determined by a hardware processor 102 executing machine readable code instructions 112 to measure the grayscale pixel value (having a value between zero and 255). Orienting the linear or x-shaped dual-armed phase-shifting nanostructures for a given sub-pixel relative to the incident light may be used to phase and amplitude shift the light refracted by that linear or x-shaped dual-armed phase-shift nanostructure. Alignment of the dual-armed phase-shifting nanostructure, or having a phase shift angle of zero in an example embodiment may give a brightness of 255, which allows a highest light amplitude to pass through the sub-pixel and maximize brightness. Orienting the linear or x-shaped dual-armed phase-shifting nanostructure of a given sub-pixel at an phase-shift angle of 90 degrees with respect to incident light in another example embodiment may give a brightness of zero, which allows limited or no light to pass through the sub-pixel and minimize brightness. These are only examples of possible phase-shift angles of arranging the linear dual-armed phase-shift nanostructures or sides or portions of the x-shaped dual-armed phase-shift nanostructures for correlating to brightness values. It is contemplated that any angle between zero and 180 degrees may correlate to any brightness value between zero and 255, although 180 degrees and 0 degrees may have the same effect on brightness and such correlations may, in some cases, be determined through empirical testing. In order to achieve brightness values between zero and 255 in an embodiment, a hardware processor executing machine readable code instructions may correlate an phase-shift angle of a percentage between zero and 90 degrees to a percentage of known brightness for a given pixel that is between zero and 255. Disposing a plurality of sub-pixel nanostructures incorporating such linear or x-shaped dual-armed phase-shifting nanostructures in such a way determine how to layout sub-pixels and pixels of the phase-shifting metasurface 160 at block 604 in an embodiment. A pixel and sub-pixel layout, such as a 5×5 pixel with red-green-blue subpixels or other known pixel and sub-pixel layouts maybe selected in advance to determine a known number of pixels to be used in the phase-shifting metasurface of a given holographic skin in embodiments herein. With this known number of pixels and sub-pixel arrangement, the layout of the linear or x-shaped dual-armed phase-shift nanostructures of varying sizes and phase-shift angles may be determined for the holographic image to represent the user-selected image in the holographic skin.

In an embodiment at block 606, for each red sub-pixel of the phase-shifting metasurface or the holographic skin, the method includes forming a red sub-pixel nanostructure of refractive material having a first permittivity for light, such as polysilicon, as a red linear or x-shaped dual-armed phase-shifting nanostructure. The length of the portions or sides of the x-shaped dual-armed phase-shifting nanostructures or length of the linear dual-armed phase-shifting nanostructures formed are set for diffracting light at a resonance frequency for red light that measures less than one wavelength of visible light, for example a quarter-wavelength. A phase-shifting metasurface may be formed in an embodiment by disposing a plurality of linear or x-shaped dual-armed nanostructures having a first permittivity across a substrate material having a second permittivity for light in a pattern of pixels. Each pixel is formed by one or more sub-pixel nanostructures, each comprising one or more linear or x-shaped dual-armed phase-shifting nanostructures dimensioned for the specific color, such as red, green, or blue. Each of these dual-armed phase-shifting nanostructures may have a length designed specifically for the display of red, green, or blue wavelengths in embodiments herein.

For example, in an embodiment described with respect to FIG. 2B, the linear dual-armed phase-shifting nanostructure 242 may have a length 241, such as a quarter-wavelength, designed specifically for the display of red wavelengths. The red linear dual-armed phase-shifting nanostructure in such an embodiment may be oriented at a phase shift angle with respect to incident light that adjusts the amplitude for brightness of the given red sub-pixel determined for the pre-selected image at that pixel or sub-pixel as determined above. For example, in an embodiment described with respect to FIGS. 2A to 2E, each red sub-pixel linear dual-armed phase-shifting nanostructure 242 of the holographic skin may have a length 241 and formed of refractive material of a first permittivity different than the permittivity of substrate. Further, the red sub-pixel linear dual-armed phase-shifting nanostructures 242a, 242b, 242c may be formed at various phase-shift angles (e.g. 247a, 247b, 247c or others between 0 and 180) in a red subpixel 251 for controlling the brightness of light passing through a given sub-pixel 251 as described in the example embodiment of FIG. 2E.

As another example embodiment described with respect to FIG. 3B, an x-shaped dual-armed phase-shifting nanostructure 361a, 361b, or 361c have a length 397a, such as a quarter-wavelength, designed specifically for the display of red wavelengths. The length 397a may apply to each side or portion 340a, 341a, 340b, 341b, 340c, or 341c of the red x-shaped dual-armed phase-shifting nanostructure 361a, 361b, or 361c. The sides or portions 340a, 341a, 340b, 341b, 340c, or 341c of each red x-shaped dual-armed phase-shifting nanostructure 361a, 361 b, or 361c in such an embodiment may be oriented at plural phase shift angles 347 and 348, as depicted in FIG. 3D, with respect to incident light. These phase shift angles 347 and 348 adjust the amplitude and phase for brightness and color shade of the given red sub-pixel 351 determined for the pre-selected image at that pixel or sub-pixel. For example, in an embodiment described with respect to FIGS. 3A to 3D, each red x-shaped dual-armed phase-shifting nanostructure 361a, 361b, or 361c of the holographic skin may have a length 397a and formed of refractive material of a first permittivity different than the permittivity of substrate. Further, the red x-shaped dual-armed phase-shifting nanostructure 361a, 361b, or 361c may be formed at various phase-shift angles (e.g. 347 and 348 or others between 0 and 180) in a red subpixel 351 or 351a, 351b, 351c, 351d for controlling the brightness and shade of red of light passing through a given sub-pixel 351 or 351a, 351b, 351c, 351d as described in the example embodiments herein. Any pixel and sub-pixel arrangement including one or more red linear dual-armed phase-shifting nanostructure 242a, 242b, or 242c or red x-shaped dual-armed phase-shifting nanostructures 361a, 361b, or 361c is contemplated for a phase-shifting metasurface in embodiments herein.

At block 608, for each green sub-pixel of the phase-shifting metasurface or the holographic skin, the method includes forming a green sub-pixel nanostructure of refractive material having a first permittivity for light, such as polysilicon, as a green linear or x-shaped dual-armed phase-shifting nanostructure. The length of the portions or sides of the x-shaped dual-armed phase-shifting nanostructures or length of the linear dual-armed phase-shifting nanostructures formed are set for diffracting light at a resonance frequency for green light that measures less than one wavelength of visible light, for example a quarter-wavelength. A phase-shifting metasurface may be formed in an embodiment by disposing a plurality of linear or x-shaped dual-armed nanostructures having a first permittivity across a substrate material having a second permittivity for light in a pattern of pixels. Each pixel is formed by one or more sub-pixel nanostructures, each comprising one or more linear or x-shaped dual-armed phase-shifting nanostructures dimensioned for the specific color, such as red, green, or blue. Each of these dual-armed phase-shifting nanostructures may have a length designed specifically for the display of red, green, or blue wavelengths in embodiments herein.

For example, in an embodiment described with respect to FIG. 2B, the linear dual-armed phase-shifting nanostructure 244 may have a length 243, such as a quarter-wavelength, designed specifically for the display of green wavelengths. The green linear dual-armed phase-shifting nanostructure in such an embodiment may be oriented at a phase shift angle with respect to incident light that adjusts the amplitude for brightness of the given green sub-pixel determined for the pre-selected image at that pixel or sub-pixel. For example, in an embodiment described with respect to FIGS. 2A to 2E, each green sub-pixel linear dual-armed phase-shifting nanostructure 244 of the holographic skin may have a length 243 and formed of refractive material of a first permittivity different than the permittivity of substrate. Further, the green sub-pixel linear dual-armed phase-shifting nanostructures 244a, 244b, 244c may be formed at various phase-shift angles (e.g. 248b, 248c or others between 0 and 180) in a green subpixel 252 for controlling the brightness of light passing through a given sub-pixel 252 as described in the example embodiment of FIG. 2E.

As another example embodiment described with respect to FIG. 3B, an x-shaped dual-armed phase-shifting nanostructure 362a, 362b, or 362c have a length 397b, such as a quarter-wavelength, designed specifically for the display of green wavelengths. The length 397b may apply to each side or portion 342a, 343a, 342b, 343b, 342c, or 343c of the green x-shaped dual-armed phase-shifting nanostructure 362a, 362b, or 362c. The sides or portions 342a, 343a, 342b, 343b, 342c, or 343c of each green x-shaped dual-armed phase-shifting nanostructure 362a, 362 b, or 362c in such an embodiment may be oriented at plural phase shift angles 347 and 348, as depicted in FIG. 3D, with respect to incident light. These phase shift angles 347 and 348 adjust the amplitude and phase for brightness and color shade of the given green sub-pixel 352 determined for the pre-selected image at that pixel or sub-pixel. For example, in an embodiment described with respect to FIGS. 3A to 3D, each green x-shaped dual-armed phase-shifting nanostructure 362a, 362b, or 362c of the holographic skin may have a length 397b and formed of refractive material of a first permittivity different than the permittivity of substrate. Further, the green x-shaped dual-armed phase-shifting nanostructure 362a, 362b, or 362c may be formed at various phase-shift angles (e.g. 347 and 348 or others between 0 and 180) in a green subpixel 352 or 352a, 352b, 352c, 352d for controlling the brightness and shade of green of light passing through a given sub-pixel 352 or 352a, 352b, 352c, 352d as described in the example embodiments herein. Any pixel and sub-pixel arrangement including one or more green linear dual-armed phase-shifting nanostructure 244a, 244b, or 244c or green x-shaped dual-armed phase-shifting nanostructures 362a, 362b, or 362c is contemplated for a phase-shifting metasurface in embodiments herein.

At block 608, for each blue sub-pixel of the phase-shifting metasurface or the holographic skin, the method includes forming a blue sub-pixel nanostructure of refractive material having a first permittivity for light, such as polysilicon, as a blue linear or x-shaped dual-armed phase-shifting nanostructure. The length of the portions or sides of the x-shaped dual-armed phase-shifting nanostructures or length of the linear dual-armed phase-shifting nanostructures formed are set for diffracting light at a resonance frequency for blue light that measures less than one wavelength of visible light, for example a quarter-wavelength. A phase-shifting metasurface may be formed in an embodiment by disposing a plurality of linear or x-shaped dual-armed nanostructures having a first permittivity across a substrate material having a second permittivity for light in a pattern of pixels. Each pixel is formed by one or more sub-pixel nanostructures, each comprising one or more linear or x-shaped dual-armed phase-shifting nanostructures dimensioned for the specific color, such as red, green, or blue. Each of these dual-armed phase-shifting nanostructures may have a length designed specifically for the display of red, green, or blue wavelengths in embodiments herein.

For example, in an embodiment described with respect to FIG. 2B, the linear dual-armed phase-shifting nanostructure 246 may have a length 245, such as a quarter-wavelength, designed specifically for the display of green wavelengths. The blue linear dual-armed phase-shifting nanostructure in such an embodiment may be oriented at a phase shift angle with respect to incident light that adjusts the amplitude for brightness of the given blue sub-pixel determined for the pre-selected image at that pixel or sub-pixel. For example, in an embodiment described with respect to FIGS. 2A to 2E, each blue sub-pixel linear dual-armed phase-shifting nanostructure 246 of the holographic skin may have a length 245 and formed of refractive material of a first permittivity different than the permittivity of substrate. Further, the blue sub-pixel linear dual-armed phase-shifting nanostructures 246a, 246b, 246c may be formed at various phase-shift angles (e.g. 249a, 249b, 249c or others between 0 and 180) in a blue subpixel 253 for controlling the brightness of light passing through a given sub-pixel 253 as described in the example embodiment of FIG. 2E.

As another example embodiment described with respect to FIG. 3B, an x-shaped dual-armed phase-shifting nanostructure 363a, 363b, or 363c have a length 397c, such as a quarter-wavelength, designed specifically for the display of blue wavelengths. The length 397c may apply to each side or portion 344a, 345a, 344b, 345b, 344c, or 345c of the blue x-shaped dual-armed phase-shifting nanostructure 363a, 363b, or 363c. The sides or portions 344a, 345a, 344b, 345b, 344c, or 345c of each blue x-shaped dual-armed phase-shifting nanostructure 363a, 363 b, or 363c in such an embodiment may be oriented at plural phase shift angles 347 and 348, as depicted in FIG. 3D, with respect to incident light. These phase shift angles 347 and 348 adjust the amplitude and phase for brightness and color shade of the given blue sub-pixel 353 determined for the pre-selected image at that pixel or sub-pixel. For example, in an embodiment described with respect to FIGS. 3A to 3D, each blue x-shaped dual-armed phase-shifting nanostructure 363a, 363b, or 363c of the holographic skin may have a length 397c and formed of refractive material of a first permittivity different than the permittivity of substrate. Further, the green x-shaped dual-armed phase-shifting nanostructure 363a, 363b, or 363c may be formed at various phase-shift angles (e.g. 347 and 348 or others between 0 and 180) in a blue subpixel 353 or 353a, 353b, 353c, 353d for controlling the brightness and shade of blue of light passing through a given sub-pixel 353 or 353a, 353b, 353c, 353d as described in the example embodiments herein. Any pixel and sub-pixel arrangement including one or more blue linear dual-armed phase-shifting nanostructure 246a, 246b, or 246c or blue x-shaped dual-armed phase-shifting nanostructures 363a, 363b, or 363c is contemplated for a phase-shifting metasurface in embodiments herein.

At block 612, the red, green, or blue sub-pixel nanostructures are formed as described above for each sub-pixel in the phase-shifting metasurface for a holographic skin. Each of the red, green, or blue sub-pixel nanostructures are disposed in a pre-determined pixel and sub-pixel layout according to embodiments herein on a transparent substrate material, such as glass, having a different permittivity than the polysilicon material of the red, green, and blue sub-pixel nanostructures. The phase-shift angles for each of the red, green or blue sub-pixel nanostructures are correlated to the color shades and brightness of the pre-selected image to be represented as a holographic image for the phase-shifting metasurface at that pixel of the holographic skin.

As described herein, a user of an information handling system may select a holographic image for the metasurface. A hardware processor in an embodiment executing machine readable code instructions of a Gerchberg-Saxton algorithm may determine, for a known number of pixels of the metasurface, one or more phase-shift angles for each pixel or sub-pixel needed to produce the brightness and color shades of a pre-selected holographic image. Such determined phase-shift angles in an embodiment may correlate to an angle at which a red, green, or blue sub-pixel linear or x-shaped dual-armed phase-shifting nanostructures may be oriented with respect to a reference line correlated to the angle of incoming incident light to produce a color shade and brightness needed to project a portion of the pre-selected holographic image. In other words, rotating a given red, green, or blue linear or x-shaped dual-armed phase-shifting nanostructure of a sub-pixel nanostructure by the one or more phase-shift angles depending on type in pixels may shift the color shades and brightness made visible by that sub-pixel nanostructure to various shades of red, green, and blue, depending on the length of the sub-pixel nanostructure. This may provide a gradient of colors perceived by the user within the selected image. As described herein, as incident light passes between the material permittivity of the substrate, such as glass, to the second material permittivity, such as polysilicon, of each of the dual-armed nanostructures formed on the substrate, the light is refracted and reflected at the material intersection and by the length and phase angle(s) of the red, green, or blue sub-pixel nanostructures. This refracting and reflecting at the red, green, or blue sub-pixel nanostructures causes constructive or destructive interference in the light to polarize and adjust amplitude for a determined color shade and brightness at that pixel of the metasurface holographic skin as assigned for the pre-selected holographic image to be displayed. Each pixel of the metasurface holographic skin in an embodiment may comprise one or more red sub-pixels, green sub-pixels, and blue sub-pixels as described.

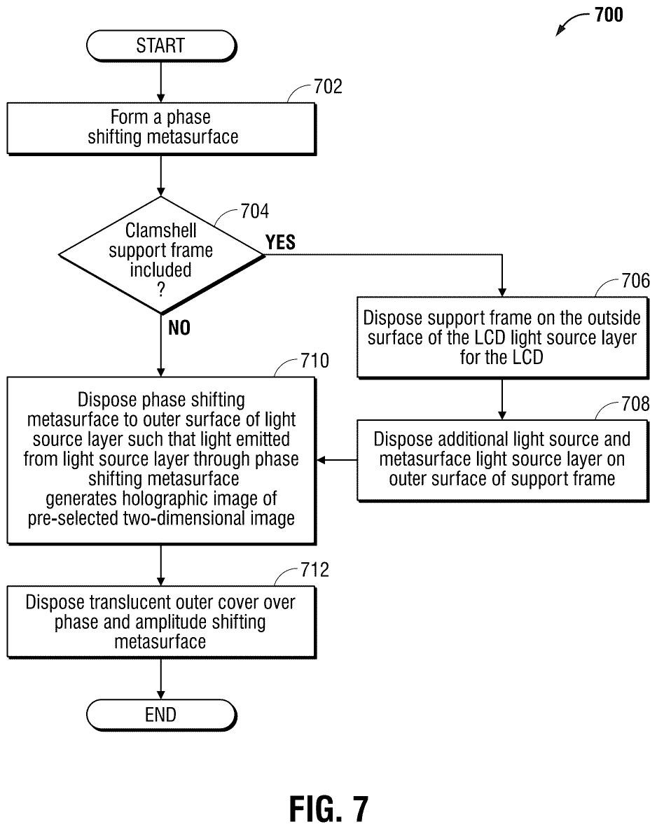

FIG. 7 is a flow diagram illustrating a method of assembling a holographic skin for displaying a holographic image, via a phase-shifting metasurface, for an information handling system chassis top cover outside surface according to an embodiment of the present disclosure. As described herein, the phase-shifting metasurface with a plurality of x-shaped dual-armed phase-shifting nanostructures may be used in such an embodiment where holographic image display richness or depth are more important, such as in the display of a user-selected image with a holographic skin on an exterior surface of a laptop clamshell chassis top cover. This will allow individuals around the laptop information handling system to view the holographic image projected via the phase-shifting metasurface while the laptop is in use.

At block 702, a phase-shifting metasurface may be formed in an embodiment. In an example embodiment described with respect to FIGS. 3A, 3B, 3C, and 3D, a phase-shifting metasurface may be formed utilizing a plurality of x-shaped dual-armed phase-shifting nanostructures. The x-shaped dual-armed phase-shifting nanostructures allow for greater depth and color variation and brightness in pixels as well as greater pixel density, but are more complicated to produce than linear dual-armed phase-shifting nanostructures in an example embodiment. It is contemplated however, that linear dual-armed phase-shifting nanostructures may be used for the phase-shifting metasurface of the clamshell cover holographic skin application in some embodiments. Such a phase-shifting metasurface including x-shaped dual-armed phase-shifting nanostructures of a material with a first permittivity may be formed on a substrate of a different permittivity in various embodiments herein using the method of FIG. 6, above. The clamshell holographic skin may depict holographic images selectable by a user with a great deal of depth of colors and brightness for display on the top cover of an information handling system, such as a laptop, or any surface of an information handling system of a variety of types.

In an embodiment at block 704, it may be determined whether the information handling system chassis top cover encloses a support frame that requires an additional light source layer coupled to the phase-shifting metasurface. As described herein, the light source layer in some embodiments may be the light source layer for a digital display device, such as an LCD backlight or light from an OLED display, in the display chassis for the information handling system under the display chassis top cover. In other embodiments, an opaque support frame through which light may not pass, or through which the passage of light may be hindered may be disposed between the phase-shifting metasurface and the light source for the digital display device. If the information handling system chassis top cover encloses a support frame disposed between the light source layer for the digital display device and the chassis top cover outer surface from which the holographic image is to be displayed as in the latter scenario, the method may proceed to block 706 for addition of a second light source or second light source layer between the support frame and the chassis top cover outer surface. If the information handling system chassis top cover does not enclose a support frame disposed to block the light source layer for the digital display device at the display chassis top cover outer surface from which the holographic image is to be displayed as in the former scenario, such an additional light source layer may not be necessary, and the method may proceed to block 710.

At block 706, in an embodiment in which the information handling system chassis top cover encloses a support frame disposed between the light source layer for the digital display device and the chassis top cover outer surface from which the holographic image is to be displayed, a support frame may be disposed on the outside surface of the LCD light source layer for the LCD or digital display device. For example, in an embodiment described with reference to FIG. 4B, an opaque support frame 465 through which light may not pass, or through which the passage of light may be hindered may be disposed between the phase-shifting metasurface 460 and the light source 471 for the digital display device. In such an embodiment, an additional metasurface light source layer 464 or a light source 465 may be added for the emission of light through the substrate and the x-shaped dual-armed phase-shifting nanostructures of the phase-shifting metasurface 460.

In an embodiment at block 708, an additional light source, such as low-power LED lasers, and a metasurface light source layer may be disposed on the outer surface of the support frame. In an embodiment in which the information handling system chassis top cover encloses a support frame 465 disposed between the light source layer 471 for the digital display device and the translucent chassis top outer cover 464 from which the holographic image is to be displayed. The support frame 465 may be disposed on the outside surface of the LCD light source layer 471 for the LCD or digital display device to provide structural support for the chassis top cover, but may block light from the LCD light source layer. Thus, an additional light source 463, such as low power red, green, and blue light emitting diode (LED) lasers, are installed on the support frame 465 and provided low power source to illuminate the substrate of the phase-shifting metasurface 460 directly or via the light source layer 471 to achieve the incident light angle on to the phase-shifting metasurface 460.

At block 710, the phase-shifting metasurface in an embodiment may be mounted to an outer surface of either the LCD light source layer, directly on the support structure of the clamshell outer display chassis, or on an additional metasurface light source layer, such that light is emitted from the additional light source or the light source layer at a determined incident light angle through the phase-shifting metasurface. With the incident light angle of light from the additional light source or the light source layer into the substrate of the phase-shifting metasurface, the phase-shifting metasurface generates a holographic image as the holographic skin on the clamshell outer surface of the display chassis of the information handling system. For example, in an embodiment described with respect to FIG. 4B in which light from the light source layer 471 of a digital display device 470 is emitted and directed at an incident light angle through the substrate of the phase-shifting metasurface 460, the phase-shifting metasurface 460 may be disposed beside a light source layer 471 with any direction of the light through light guide or other measure from the digital display device 470 within the laptop display chassis top cover. The light source layer 471 in such an embodiment may emit light through the phase-shifting metasurface 460, having a plurality of sub-pixel nanostructures, each comprising two portions of each x-shaped dual-armed phase-shifting nanostructures in an embodiment and oriented at plural phase-shift angles to project light of a specific color and brightness for a pixel or sub-pixel to project a user-selected holographic image with high quality color resolution and depth, as described in greater detail herein.

In another example embodiment described with respect to FIG. 4C, the metasurface light source layer 466 may be disposed between the support frame 465 that blocks light from the digital display device 470 and the phase-shifting metasurface 460, such that light is emitted from an additional light source 463 and any metasurface light source layer 466 through the substrate of the phase-shifting metasurface 460 at a directed incident angle of light. This light incident on the substrate of the phase-shifting metasurface 460 and its plurality of x-shaped dual-armed phase-shifting nanostructures may refract and reflect light at pixels of selected color and brightness for generating a holographic image in the clamshell outer cover display chassis holographic skin.

A translucent outer cover may be disposed atop the phase-shifting metasurface in an embodiment at block 712. For example, in embodiments described with respect to FIGS. 4B and 4C, translucent outer cover 464 may be disposed on top of the x-shaped dual-armed phase-shifting nanostructures and substrate of the phase-shifting metasurface 460 to form the holographic skin for display of a pre-selected holographic image on the outside clamshell surface of the display chassis top cover. The method for assembling an information handling system top cover outside surface for displaying a holographic image with a clamshell display chassis holographic skin via a phase-shifting metasurface may then end.

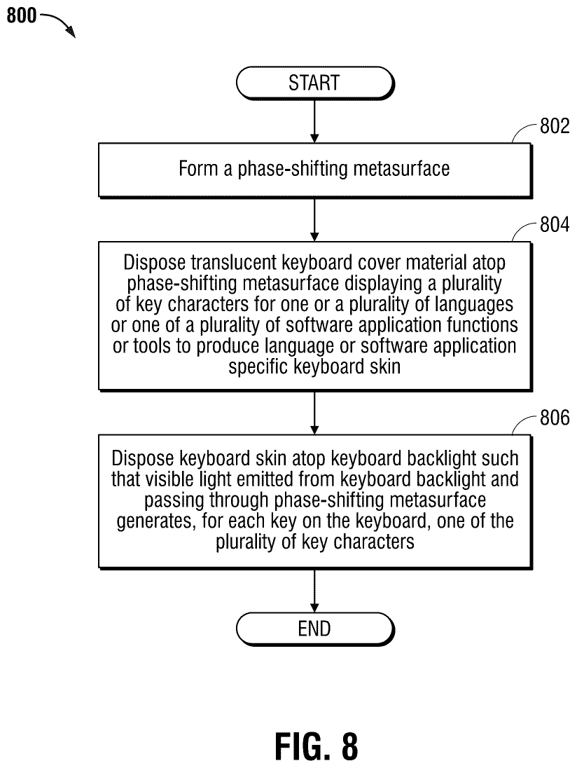

FIG. 8 is a flow diagram illustrating a method of assembling a keyboard holographic skin for displaying a holographic image via a phase-shifting metasurface according to an embodiment of the present disclosure. As described herein, the phase-shifting metasurface may be used in embodiments herein for holographic images that do not require a large range of depth or brightness, such as for characters on keys of a keyboard.

At block 802, a phase-shifting metasurface may be formed in an embodiment. For example, a phase-shifting metasurface, as described in an embodiment with respect to FIGS. 2A, 2B, 2C, 2D, and 2E may be formed in an embodiment. The phase-shifting metasurface may include a plurality of linear dual-armed phase-shifting nanostructures forming red, green, or blue subpixels disposed on a substrate. Use of such a plurality of linear dual-armed phase-shifting nanostructures in pixels of the phase-shifting metasurface in embodiments herein provide for holographic images that do not require a large range of depth or brightness, such as for the characters on keys of the keyboard. The linear dual-armed phase-shifting nanostructures are simpler and less complicated but may not yield pixel density and depth of color or brightness as x-shaped dual-armed phase-shifting nanostructures in an example embodiment. It is contemplated however, that x-shaped dual-armed phase-shifting nanostructures may be used for the phase-shifting metasurface of the keyboard holographic skin in some embodiments. Formation of such a phase-shifting metasurface, with either linear dual-armed phase-shifting nanostructures or x-shaped dual-armed phase-shifting nanostructures may be formed in various embodiments herein using the method of FIG. 6, above. The keyboard holographic skin may depict holographic images of plurality of key characters for one or a plurality of languages or one of a plurality of software application functions or tools in example embodiments with the formed phase-shifting metasurfaces disposed on keycaps or keytops of a keyboard.

In an embodiment at block 804, a translucent keyboard cover material may be disposed atop the phase-shifting metasurface displaying a plurality of key characters for one or a plurality of languages or one of a plurality of software application functions or tools to produce a language or software application specific keyboard skin. For example, in an embodiment described with respect to FIG. 5, a phase-shifting metasurface 582 may be disposed between a keyboard backlight 581 and a transparent keyboard cover layer 583 to protect the phase-shifting metasurface 582 materials from outside contamination during use. In another example embodiment described with respect to FIG. 2E depicting a pixel of a holographic image with a phase-shifting metasurface in which the holographic image is to be displayed on a keyboard skin on keys of a keyboard within the information handling system chassis base cover, a translucent keyboard cover material may be disposed atop the plurality of pixels of phase-shifting metasurface 260 displaying a plurality of key characters for one or a plurality of languages or one of a plurality of software application functions or tools to produce a language or software application specific keyboard skin.

The keyboard skin in an embodiment at block 806 may be disposed atop a keyboard backlight such that visible light emitted from the keyboard backlight and passing through the phase-shifting metasurface generates, for each key on the keyboard, a holographic image one of the plurality of key characters. For example, in an embodiment described with respect to FIG. 5, the phase-shifting metasurface 582 may be disposed between a keyboard backlight 581 and a transparent keyboard cover layer 583 to protect the phase-shifting metasurface 582 materials from outside contamination during use. The keyboard backlight 581 in such an embodiment may emit light through a keycap or a keyboard key surface and into the phase-shifting metasurface 582 of the holographic skin installed or disposed on top of the keycap or keyboard key surface. The light from the keyboard backlight 581 may pass through the phase-shifting metasurface 582, having a plurality of sub-pixels, each comprising one or more linear dual-armed phase-shifting nanostructures oriented at a phase-shift angle to project light of a specific color, including black, and color shades to project an image of a language character or a keyboard shortcut character for a known software application on the surface of the keyboard key. In such a way, a keyboard holographic skin 584 may be assembled to incorporate a phase-shifting metasurface 582 may be assembled for the display of language-specific or application-specific keyboard characters when the keyboard holographic skin 584 is installed or formed onto the keyboard keys. In some embodiments, the keyboard holographic skin may be installed by fitting over the keyboard key such as with an interference fit, interaction of magnets, or by some other attachment method. In this embodiment, the keyboard holographic skin and holographic image of the phase-shifting metasurface is interchangeable on the keyboard keys. In other embodiments, the keyboard holographic skin may be disposed onto the keys of a keyboard such that the substrate for the phase-shifting metasurface is deposited or formed onto or as part of the keyboard keys. In this embodiment, the keyboard holographic skin and holographic image of the phase-shifting metasurface is more permanently formed on the keyboard keys. The method for assembling a keyboard holographic skin for displaying a holographic image of a plurality of language-specific or application-specific keyboard characters via a phase-shifting metasurface may then end.

The blocks of the flow diagram of FIGS. 6, 7, and 8 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A phase-shifting metasurface for display of a pre-selected holographic image via a keyboard cover holographic skin for an information handling system base chassis comprising:
a transparent metasurface substrate having a first permittivity value;
a plurality of linear dual-armed phase-shifting nanostructures formed of a refractive material having a second permittivity value disposed on the transparent metasurface substrate, where the plurality of linear dual-armed phase-shifting nanostructures correlate to a plurality of sub-pixels for display of the pre-selected holographic image;
the plurality of linear dual-armed phase-shifting nanostructures arranged in pixels on the phase-shifting metasurface including a plurality of red sub-pixel nanostructures, each including a red linear dual-armed phase-shifting nanostructure dimensioned for refracting visible light at a first resonance frequency for red light, a plurality of green sub-pixel nanostructures, each including a green linear dual-armed phase-shifting nanostructure dimensioned for refracting visible light at a second resonance frequency for green light, and a plurality of blue sub-pixel nanostructures, each including a blue linear dual-armed phase-shifting nanostructure dimensioned for refracting visible light at a third resonance frequency for blue light; and
each of the plurality of linear dual-armed phase-shifting nanostructures are disposed atop the transparent metasurface substrate at a phase-shift angle relative to an angle of incoming incident light that matches a determined phase-shift for one of the plurality of sub-pixels for the holographic projected image for controlling a brightness of the light refracted by the respective red sub-pixel nanostructures, green sub-pixel nanostructures, and blue sub-pixel nanostructures in the pixels of the displayed pre-selected holographic image.

2. The phase-shifting metasurface of claim 1, wherein the keyboard cover holographic skin is fitted over a keyboard in the base chassis and is removable for replacement with a second keyboard cover holographic skin for a second displayed pre-selected holographic image.

3. The phase-shifting metasurface of claim 2, wherein the displayed pre-selected holographic image includes a keyboard character representing a writing character a first keyboard language selected from a plurality of keyboard cover holographic skins.

4. The phase-shifting metasurface of claim 1, wherein the displayed pre-selected holographic image of the keyboard cover holographic skin includes a plurality of keyboard characters representing a keyboard language for keys on a keyboard in the information handling system base chassis.

5. The phase-shifting metasurface of claim 1, wherein the displayed pre-selected holographic image of the keyboard cover holographic skin includes a plurality of keyboard characters representing function keys on a keyboard in the information handling system base chassis for operation with a specified software application.

6. The phase-shifting metasurface of claim 1, wherein a material for the transparent metasurface substrate is glass having the first permittivity value and the refractive material of the plurality of linear dual-armed phase-shifting nanostructures is a polysilicon material having the second permittivity value.

7. The phase-shifting metasurface of claim 1 further comprising:
a translucent outer cover material disposed atop the phase-shifting metasurface to form the keyboard cover holographic skin for operable coupling to at least one key of a keyboard in the information handling system base chassis; and
the keyboard cover holographic skin disposed atop a keyboard backlight of the at least one key such that visible light emitted from the keyboard backlight is passing through the phase-shifting metasurface to generate the displayed pre-selected holographic image.

8. A method of assembling a phase-shifting metasurface for the display of a pre-selected holographic image in a holographic skin on an information handling system chassis comprising:
determining, for each of a plurality of pixels in a pre-selected image, a phase-shift angle correlating to a color shade value of the pre-selected image for generation of a pre-selected holographic image of the pre-selected image to be displayed via the phase-shifting metasurface;
disposing on the transparent metasurface substrate having a first permittivity value a plurality of dual-armed phase-shifting nanostructures formed of a refractive material having a second permittivity value, where the plurality of dual-armed phase-shifting nanostructures are dimensioned less than one wavelength of visible light to include a plurality of red sub-pixel nanostructures, each including a red dual-armed phase-shifting nanostructure dimensioned for refracting visible light at a first resonance frequency for red light, a plurality of green sub-pixel nanostructures, each including a green dual-armed phase-shifting nanostructure dimensioned for refracting visible light at a second resonance frequency for green light, and a plurality of blue sub-pixel nanostructures, each including a blue dual-armed phase-shifting nanostructure dimensioned for refracting visible light at a third resonance frequency for blue light to correlate to a plurality of sub-pixels for display of the pre-selected holographic image;
disposing each of the plurality of dual-armed phase-shifting nanostructures upon the transparent metasurface substrate having the first permittivity value in an arrangement of pixels and at a length dimension and a phase-shift angle relative to an angle of incoming incident light that matches a determined phase-shift for the pre-selected image for controlling a color and brightness at each of the plurality of sub-pixels for the pre-selected holographic image in the phase-shifting metasurface of the holographic skin; and
operatively coupling the holographic skin with the phase-shifting metasurface to an information handling system chassis with a light source for display of the pre-selected holographic image.

9. The method of claim 8, wherein a material for the transparent metasurface substrate is glass having the first permittivity value and the refractive material of the plurality of dual-armed phase-shifting nanostructures is a polysilicon material having the second permittivity value.

10. The method of claim 8 further comprising:
disposing translucent outer cover material disposed atop the phase-shifting metasurface to form the holographic skin.

11. The method of claim 8 further comprising:
operatively coupling the holographic skin on a keyboard in an information handling system base chassis and atop a keyboard backlight as the light source such that visible light emitted from the keyboard backlight passes through the phase-shifting metasurface to generate the pre-selected holographic image as a keyboard key character.

12. The method of claim 8 further comprising:
operatively coupling the holographic skin on an outer clamshell surface of an information handling system display chassis such that a digital display device is the light source such that visible light emitted from the digital display device passes through the phase-shifting metasurface to generate the pre-selected holographic image on the outer clamshell surface of the information handling system display chassis.

13. The method of claim 8 further comprising:
operatively coupling the holographic skin on an outer clamshell surface of an information handling system display chassis the light source such that visible light emitted from the light source passes through the phase-shifting metasurface to generate the pre-selected holographic image on the outer clamshell surface of the information handling system display chassis.

14. The method of claim 8, wherein the plurality of dual-armed phase-shifting nanostructures are a plurality of linear dual-armed phase-shifting nanostructures.

15. The method of claim 8, wherein the plurality of dual-armed phase-shifting nanostructures are a plurality of x-shaped linear dual-armed phase-shifting nanostructures each having a first portion and a second portion arranged in an x-shape structure at an intersection of each x-shaped linear dual-armed phase-shifting nanostructure.

16. A display chassis top cover for an information handling system with a phase-shifting metasurface for display of a pre-selected holographic image in holographic skin comprising:
a transparent metasurface substrate having a first permittivity value;
a plurality of x-shaped dual-armed phase-shifting nanostructures formed of a refractive material having a second permittivity value disposed on the transparent metasurface substrate, where the plurality of x-shaped dual-armed phase-shifting nanostructures have two portions arranged in an x-shape structure at an intersection and correlate to a plurality of sub-pixels for display of the pre-selected holographic image;
the plurality of x-shaped dual-armed phase-shifting nanostructures arranged in pixels on the phase-shifting metasurface including a plurality of red sub-pixel nanostructures, each including a red x-shaped dual-armed phase-shifting nanostructure dimensioned for refracting visible light at a first resonance frequency for red light, a plurality of green sub-pixel nanostructures, each including a green x-shaped dual-armed phase-shifting nanostructure dimensioned for refracting visible light at a second resonance frequency for green light, and a plurality of blue sub-pixel nanostructures, each including a blue x-shaped dual-armed phase-shifting nanostructure dimensioned for refracting visible light at a third resonance frequency for blue light; and
each of the plurality of x-shaped dual-armed phase-shifting nanostructures are disposed atop the transparent metasurface substrate at a first phase-shift angle of the first portion and a second phase-shift angle of the second portion of each x-shaped dual-armed phase-shifting nanostructure relative to an angle of incoming incident light from a light source that matches a determined phase shift and amplitude shift for one of the plurality of sub-pixels for the holographic projected image to controlling a brightness and color shade of the light refracted by the respective red sub-pixel nanostructures, green sub-pixel nanostructures, and blue sub-pixel nanostructures in the pixels of the displayed pre-selected holographic image.

17. The display chassis top cover for the information handling system of claim 16, wherein the light source includes a light source layer for a digital display device within the display chassis top cover such that the visible light emitted from the digital display device passes through the phase-shifting metasurface to generate the pre-selected holographic image on the display chassis top cover of the information handling system.

18. The display chassis top cover for the information handling system of claim 16 further comprising:
a chassis support frame disposed between the digital display device within the display chassis top cover and the phase-shifting metasurface of the holographic skin; and
the light source formed on the chassis support frame such that the visible light emitted from the light source passes through the phase-shifting metasurface to generate the pre-selected holographic image on the display chassis top cover of the information handling system.

19. The display chassis top cover the information handling system of claim 16, wherein the displayed pre-selected holographic image is user-selected for display on the exterior surface of the chassis top cover in the holographic skin operatively coupled to the display chassis top cover and the holographic skin is removable for replacement with a second holographic skin with a second displayed pre-selected holographic image.

20. The display chassis top cover for the information handling system of claim 16, wherein a material for the transparent metasurface substrate is glass having the first permittivity value and the refractive material of the plurality of x-shaped dual-armed phase-shifting nanostructures is a polysilicon material having the second permittivity value.
